(19) United States
(12) Patent Application Publication
(10) Pub. No.: US 2023/0397194 A1
(43) Pub. Date: Dec. 7, 2023

(54) Apparatuses and Methods for Scheduling Resources

(71) Applicant: Telefonaktiebolaget LM Ericsson (PUBL), Stockholm (SE)

(72) Inventors: Min Wang, LULEÅ (SE); Jan Christoffersson, LULEÅ (SE)

(21) Appl. No.: 18/033,220

(22) PCT Filed: Oct. 26, 2020
(86) PCT No.: PCT/EP2020/080054

§ 371 Date: Apr. 21, 2023

(51) Int. Cl. H04W 72/1268; H04W 72/121

(52) U.S. Cl. CPC H04W 72/1268; H04W 72/121

(57) ABSTRACT

The present disclosure relates to telecommunications. In one of its aspects, the disclosure concerns a method in a coordinator User Equipment (UE) for scheduling resources for a group of UEs in a wireless communications system. The method comprises receiving, from a Radio Access Network (RAN) node, a configuration configuring at least the coordinator UE with group-shared UpLink (UL) resources and SideLink (SL) resources to be used by the group of UEs. The configuration further indicates that the coordinator UE coordinates scheduling of the group-shared UL resources. The method further comprises monitoring a demand for the group-shared UL resources by at least one UE within the group of UEs and scheduling, based on the monitored demand for the group-shared UL resources, the configured group-shared UL resources to at least one UE within the group of UEs.

### TECHNICAL FIELD

The present disclosure generally relates to telecommunications. In particular, the various embodiments described in this disclosure relate to apparatuses and methods for scheduling resources for a group of User Equipment (UEs) in a wireless communications system.

### BACKGROUND

This section is intended to provide a background to the various embodiments described in this disclosure. Therefore, unless otherwise indicated herein, what is described in this section should not be interpreted to be prior art by its mere inclusion in this section.

NR Operation in Mm-Wave Bands

Mobile broadband is constantly evolving and will continue to drive the demands for higher overall traffic capacity and higher achievable end-user data rates in wireless access networks. These demands may be met with a high infra-structure density, where the distances between access nodes ranging from a few meters in indoor deployments up to roughly 50 m in outdoor deployments. The wide transmission bandwidths needed to provide for these higher data rates may most likely only be obtained from spectrum allocations in the millimetre-wave band. High-gain beamforming, typically realized with array antennas, may be used to mitigate the increased pathloss at higher frequencies. In the following, such networks will be referred to as New Radio (NR) systems.

NR supports deployment at both low frequencies, hundreds of MHz, and very high frequencies, tens of GHz. Two operation frequency ranges are defined in NR Rel-FR1 from 410 MHz to 7125 MHz and FR2 from 24.250 GHz to 52.6 GHz. 3GPP RAN is in NR Rel-17 studying how to best support NR operation on FR2 frequencies, i.e. from 52.6 GHz to 71 GHz (3GPP TS 38.214 v16.1.0).

NR Frame Structure

Similar to LTE, NR uses Orthogonal Frequency Division Multiplexing (OFDM) in the downlink, i.e. from a network node to a User Equipment (UE). The network node may be, for example, a gNB, an eNB or a base station. The basic NR physical resource over an antenna port may thus be seen as a time-frequency grid as illustrated in FIG. 1. FIG. 1 shows a Resource Block (RB) 11 in a 14-symbol slot 12. The RB corresponds to 12 contiguous subcarriers in the frequency domain. The resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values, also referred to as different numerologies, are given by Δf=(15×2\hat{ }μ) kHz where μ ∈ (0,1,2,3,4). Δf=15 kHz is the basic, or reference, subcarrier spacing that is also used in LTE.

Downlink (DL) transmissions are dynamically scheduled, i.e., in each slot the gNB transmits Downlink Control Information (DCI) about which UE data is to be transmitted to and which resource blocks in the current downlink slot the data is transmitted on. This control information is typically transmitted in the first one or two OFDM symbols in each slot in NR. The control information is carried on the Physical Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded control information in the PDCCH. In addition to PDCCH and PDSCH, there are also other channels and reference signals transmitted in the downlink, including SSB, CSI-RS, etc.

Uplink data transmissions, carried on Physical Uplink Shared Channel (PUSCH), can also be dynamically scheduled by the gNB by transmitting a DCI. The DCI, which is transmitted in the DL region, indicates a scheduling time offset so that the PUSCH is transmitted in a slot in the UL region.

LTE/NR Cellular UL Dynamic Scheduling and Configured Grants

The basic procedure for transmitting UL data in 4G and 5G systems is dynamic scheduling. This is shown in FIG. 2a. In the dynamic scheduling, the UE will send a Scheduling Request (SR) 22 and/or a Buffer Status Report (BSR) 24 to the gNB to indicate that it has data (SR) to transmit and the amount of data (BSR). The gNB will then send grant(s) 23, 25 to the UE, which are tailored to the amount and priority of the data. Due to the tailored grants, dynamic scheduling is resource efficient.

A Hybrid Automatic Repeat reQuest (HARQ) protocol is widely used in 4G and systems. It will be used also in future systems to provide fast re-transmissions on the Media Access Control (MAC) layer. It is used in both UL and DL, and may be configured in different ways, e.g. the maximum number of re-transmissions, operating Block Error Rate (BLER), possible repetitions, etc. One way to implement the HARQ protocol is to use autonomous re-transmissions, i.e. the transmitter always performs a given number of HARQ retransmission attempts. Autonomous retransmissions are especially suitable in one-to-many or many-to-one communication scenarios since using HARQ feedback from many recipients or reliably transmitting HARQ feedback to many recipients is complicated. With a suitable setting for the number of HARQ transmission attempts using autonomous re-transmissions, most transmission errors can be recovered.

Another option for transmissions is using Configured Grants (CG) or Semi-Persistent Scheduling (SPS). In CG or SPS, instead of dynamically allocated resources to the UE, the network can pre-allocate or reserve resources for the UE. This is also referred to as grant-free scheduling. This means that the UE is preconfigured or semi-statically configured with periodical grants. In case the UE has data to send, it may use one of the configured grants, and in case the network needs the resource, the network may quickly deactivate or suspend the pre-configured resources permanently or for a given period of time, or the network may reconfigure the allocated resources for the UE. A benefit with configured grants is that they may have a short latency, if configured with short periodicity. However, it may lack the flexibility of dynamic grants, since TBS and coding is fixed. Furthermore, if the utilization is low, it may be wasteful with resources.

A configured grant is similar to resource allocation Mode 2 in ProSe (PROximity-based SErvices)/NR side-link, but is typically provided to a single UE, which removes the risk of colliding transmissions that may happen in ProSe, described more below.

In 3GPP TS 38.321, v16.1.0, some parameters for the configured grant, Type1, where an uplink grant is provided by RRC, are:
cs-RNTI: CS-RNTI for a retransmission;
periodicity: periodicity of the configured grant Type 1;
timeDomainOffset: Offset of a resource with respect to SFN=0 in time domain;
timeDomainAllocation: Allocation of the configured uplink grant in time domain which contains startSymbolAndLength (i.e. SLIV in TS 38.214 [7]);
nrofHARQ-Processes: the number of HARQ processes for the configured grant.

Configured Grants (CGs) may be particularly useful for small transmissions that occur frequently with deterministic or predictable periodicity. Then, the CGs may give low latency with minimal control signaling and low PUSCH overhead. In case the CG resources may not be enough for the UEs data, the UE may resort to normal dynamic scheduling by sending a BSR to the gNB, which then may give a grant suiting the needs of the UE.

SideLink in NR

SideLink (SL) transmissions over NR are specified for 3GPP Rel. 16. Sidelink is a mode of communication where two UEs communicate directly, without sending data via a gNB, often referred to as Device-to-Device (D2D). SL, first designed for first responders, may work both where there is no cellular coverage, i.e. out-of-coverage, and within a cell, i.e. in-coverage.

There have been enhancements of the ProSe specified for LTE. Four new enhancements, particularly introduced to NR sidelink transmissions, are:
Support for unicast and groupcast transmissions are added in NR sidelink. For unicast and groupcast, the physical sidelink feedback channel (PSFCH) is introduced for a receiving UE to reply the decoding status to a transmitting UE.
Grant-free transmissions, which are adopted in NR uplink transmissions, are also provided in NR sidelink transmissions, to improve the latency performance.
To alleviate resource collisions among different SL transmissions launched by different UEs, the Rel 16 specification supports enhanced channel sensing and resource selection procedures, which also lead to a new design of PSCCH.
To achieve a high connection density, congestion control, and thus the QoS management, is supported in NR SL transmissions.

To enable the above enhancements, the following physical channels and reference signals have been introduced in NR:
PSSCH (Physical Sidelink Shared Channel, SL version of PDSCH): The PSSCH is transmitted by a sidelink transmitting UE, which conveys sidelink transmission data, System Information Blocks (SIBs) for Radio Resource Control (RRC) configuration, and a part of the Sidelink Control Information (SCI).
PSFCH (Physical Sidelink, SL version of PUCCH): The PSFCH is transmitted by a sidelink receiving UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiving UE arrives at a transmitting UE, a transmitting UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (SPSS/SSSS): Similar to downlink transmissions in NR, in sidelink transmissions, primary and secondary synchronization signals, named SPSS and SSSS, respectively, are supported. Through detecting the SPSS and SSSS, a UE is able to identify the sidelink synchronization identity (SSID) from the UE sending the SPSS/SSSS. Through detecting the SPSS/SSSS, a UE is therefore able to know the characteristics of the UE transmitting the SPSS/SSSS. A series of process of acquiring timing and frequency synchronization together with SSIDs of UEs is called initial cell search. Note that the UE sending the SPSS/SSSS may not be necessarily involved in sidelink transmissions, and a node (UE/eNB/gNB) sending the SPSS/SSSS is called a synchronization source.
Physical Sidelink Broadcast Channel (PSBCH): The PSBCH is transmitted along with the SPSS/SSSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

WO 2014/130153 A1 (INTEL IP CORPORATION [US]) 28 Aug. 2014, relates to device-to-device communication with cluster coordinating. The document discloses how a cluster, or group of UEs, may be created with a cluster coordinator and further discloses that the coordinator may allocate resources to the group.

US 2019/0208539 A1 (TELEFONAKTIEBOLAGET LM ERICSSON [SE]) 4 Jul. 2019, relates to group transmissions from a group of devices to a wireless telecommunication network. The document discusses scheduling of such uplink group transmissions using device-to-device or sidelink communication.

### SUMMARY

Another new feature in NR is the two-stage SCI. This is a version of the DCI for SL. Unlike DCI, only part, first stage, of the SCI is sent on the PSCCH. This part is used for channel sensing purposes, including the reserved time-frequency resources for transmissions, demodulation reference signal (DMRS) pattern and antenna port, etc., and can be read by all UEs while the remaining, second stage, scheduling and control information such as an 8-bits source identity (ID) and a 16-bits destination ID, NDI, RV and HARQ process ID is sent on the PSSCH to be decoded by the receiving UE.

Similar as for PRoSE in LTE, NR sidelink transmissions have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.

For an in-coverage UE, a gNB may be configured to adopt Mode 1 or Mode 2. For an out-of-coverage UE, only Mode 2 may be adopted. As in LTE, scheduling over the sidelink in NR is done in different ways for Mode 1 and Mode 2.

Mode 1 supports dynamic grants and configured grants, which will be described more in detail hereinafter.

For dynamic grants, the four-message exchange procedure to request SL resources from a gNB, as illustrated in FIG. 2a, is launched by a transmitting UE when traffic to be sent over SL arrives at the UE. During the resource request procedure, the gNB may allocate a sidelink radio network temporary identifier (SL-RNTI) to the transmitting UE. If the SL resource request is granted by the gNB, the gNB may indicate the resource allocation for the PSCCH and the PSSCH in the downlink control information (DCI) conveyed by PDCCH with CRC scrambled with the SL-RNTI. When the transmitting UE receives such a DCI, the transmitting UE may obtain the grant only if the scrambled CRC of DCI may be successfully solved by the assigned SL-RNTI. The transmitting UE may then indicate the time-frequency resources and the transmission scheme of the allocated PSSCH in the PSCCH. The PSCCH and the PSSCH may be launched on the allocated resources for SL transmissions. When a grant is obtained from the gNB, the transmitting UE may only transmit a single TB. As a result, this kind of grant is suitable for traffic with a loose latency requirement.

For traffic with a strict latency requirement, performing the four-message exchange procedure to request SL resources may induce unacceptable latency. In these cases, configured grants may be used. Prior to the traffic arrival, a transmitting UE may perform the four-message exchange procedure and request a set of resources. If a grant may be obtained from a gNB, the requested resources may be reserved in a periodic manner. The gNB may also grant partial of the resources based on, e.g., the current traffic situation. Alternatively, in some case, the gNB may grant a different set of resources as long as it may guarantee the service requirements at the UE or a group of UEs. Upon traffic arriving at the transmitting UE, the UE may launch the PSCCH and the PSSCH on the upcoming resource occasion. This kind of grant is also known as grant-free transmissions.

In both dynamic grant and configured grants, depending on the UE implementation, a SL receiving UE may not be able to receive the DCI since it is addressed to the transmitting UE. Therefore, the receiving UE will perform blind decoding to identify the presence of PSCCH and to find the resources for the PSSCH through the SCI. When a transmitting UE launches the PSCCH, CRC is also inserted in the SCI without any scrambling.

In Mode 2 resource allocation, when traffic arrives at a transmitting UE, the transmitting UE may autonomously select resources for the PSCCH and the PSSCH. To minimize the latency of the feedback HARQ ACK/NACK transmissions and subsequently retransmissions further, the transmitting UE may repeat the TB transmission along with the initial TB transmission. This mechanism is also known as blind retransmission.

Since each transmitting UE in SL transmissions autonomously select resources for the above transmissions, a critical issue in Mode 2 may be how to prevent different transmitting UEs from selecting the same resources. Therefore, a particular resource selection procedure based on channel sensing is imposed to Mode 2. The channel-sensing algorithm involves measuring Reference Signal Received Power (RSRP) on different subchannels and requires knowledge of the different UEs power levels of DMRS (demodulation reference signals) on the PSSCH or the DMRS on the PSCCH, depending on the configuration. This information is known only after receiving SCI launched by the other UEs.

As previously described with reference to FIG. 2a, in dynamic scheduling, a User Equipment (UE) sends a scheduling request (SR) to a gNB. The UE then receives a grant from the gNB where the UE may send a Buffer Status Report (BSR). The UpLink (UL) transmission latency using dynamic grants may thus be estimated as:

UL latency=SR+BSR transmission time+SR+BSR processing time+grant transmission time+UE processing/encoding time+data transmission time+gNB processing/decoding (1)

In the formula (1), the UE processing time for PUSCH has been defined in the below tables, according to TS 38.214, v16.1.0.

TABLE 1
Table 6.4-1: PUSCH preparation
time for PUSCH timing capability 1

| μ | PUSCH preparation time N₂ [symbols] |
|---|---|
| 0 | 10 |
| 1 | 12 |
| 2 | 23 |
| 3 | 36 |

TABLE 2
Table 6.4-2: PUSCH preparation time
for PUSCH timing capability 2

| μ | PUSCH preparation time N₂ [symbols] |
|---|---|
| 0 | 5 |
| 1 | 5.5 |
| 2 | 11 for frequency range 1 |

FIG. 2b illustrates the delay for an NR Mobile BroadBand (MBB) scenario for a small data upload. FIG. 2b shows the additional delay compared to an ideal scenario where the UE may transmit the BSR directly, and error free, to the gNB (the genie BSE). As illustrated in FIG. 2b, the additional delay may be 10-15 ms for the worst case (90%-ile, the ellipses) and around 10 ms in average (the baseline) or roughly 30% higher delay.

For NR Rel-17 supporting NR operation from 52.6 GHz to 71 GHz, assuming that the same waveform as in NR Rel-15 will be applied, an even higher SubCarrier Spacing (SCS) value range, between 480 kHz, 960 kHz, 1920 kHz and 3840 kHz, is being considered. Following the same framework as in NR Rel-15, the UE processing time for these higher SCS would be extended to much higher value range in number of slots. In an example, for SCS 1920 kHz and 3840 kHz, the UE processing time may be increased to in a range between 15 slots up to 30 slots. Therefore, the HARQ and scheduling Round-Trip Time (RTT) measured in slots may become excessive. This implies that UL latency according to the formula (1) will become huge in terms of number of slots. Additionally, the gNB's processing load may also increase due to the shorter slot times. Thus, scheduling decisions may need to be made in advance of performing the actual transmission. An accurate scheduling decision may then not always be feasible as the UEs may not be able to report buffer status on time.

In 6G, the evolution will probably follow the same trend as in NR Rel-17. Thus, there is a need to enhance dynamic scheduling to reduce the UL latency, e.g., in slots, and reduce the processing load in both UE and gNB.

Furthermore, the problem of scheduling delay may be even larger for a Machine Type Communication (MTC)/Internet of Things (IoT) scenario with many devices with bursty data compared to an MBB scenario with few users as shown in FIG. 2b. This holds for both dynamic and CG scheduling. For the CG case, many devices may cause situations where the devices will have to wait for the configured CG or compete for the CG resources. Alternatively, the gNB may configure many CG resources to cope with the worst scenario, but that will on the other hand lead to bad usage of the resources in many cases.

Accordingly, there is a need to enhance scheduling such that UL latency, e.g., in slots, is reduced and such that processing load in both UE and gNB is reduced.

It is in view of the above background and other considerations that the various embodiments of the present disclosure have been made.

It is proposed to provide a solution to address this problem, i.e. enhance scheduling of UL resources in order to reduce latency and processing loads in situations where many UEs may transmit data.

This general object has been addressed by the appended independent claims. Advantageous embodiments are defined in the appended dependent claims.

According to a first aspect, there is provided a method in a coordinator UE for scheduling resources for a group of UEs in a wireless communications system.

The method comprises receiving, from a RAN node, a configuration configuring at least the coordinator UE with group-shared UpLink (UL) resources and SideLink (SL) resources to be used by the group of UEs. The configuration further indicates that the coordinator UE coordinates scheduling of the group-shared UL resources. The method further comprises monitoring a demand for the group-shared UL resources by at least one UE within the group of UEs. Base on the monitored demand for the group-shared UL resources, the method further comprises scheduling the configured group-shared UL resources to at least one UE within the group of UEs.

In some embodiments, the step of monitoring the demand for the group-shared UL resources comprises receiving, via the SL resources, a BSR from at least one UE within the group of UEs.

In some embodiments, the step of monitoring the demand for the group-shared UL resources further comprises monitoring a sum of requested resources in at least one BSR from at least one UE within the group of UEs. If the sum of requested resources in said at least one BSR exceeds the configured group-shared UL resources, the method further comprises transmitting, to the RAN node, a request for additional group-shared UL resources.

In some embodiments, the request for additional group-shared UL resources comprises an indication of an amount of desired group-shared UL resources based on said sum of requested resources in said at least one BSR.

In some embodiments, the request for additional group-shared UL resources comprises an aggregated BSR and the aggregated BSR comprises information of a total buffer status of all UEs within the group of UEs. The aggregated BSR may comprise an identifier indicating that the aggregated BSR is an aggregated BSR.

In some embodiments, the method further comprises receiving, from the RAN node, a configuration configuring additional group-shared UL resources as a response to said transmitted request for additional group-shared UL resources. The method may further comprises allocating partial or all the received additional group-shared UL resources to at least one UE within the group of UEs that has data to transmit.

In some embodiments, the method further comprises transmitting, to the group of UEs, a configuration configuring the group of UEs with the SL resources to be used by the group of UEs and configuring the group of UEs that the coordinator UE coordinates the use of the group-shared UL resources.

In some embodiments, the step of scheduling the configured group-shared UL resources to at least one UE within the group of UEs comprises indicating to the at least one UE within the group of UEs which group-shared UL resources to use.

In some embodiments, which group-shared UL resources the at least one UE within the group of UEs is allowed to use is indicated to said UE by indicating a timing of a configured grant for said group-shared UL resources. The step of indicating to the at least one UE within the group of UEs which group-shared UL resources to use may comprise transmitting, to said at least one UE within the group of UEs, a Downlink Control Information (DCI), using a configured search space on Physical Sidelink Common Control Channel (PDCCH).

In some embodiments, which group-shared UL resources the at least one UE within the group of UEs is allowed to use is indicated to said UE by a polling chart, which informs said UE when the group-shared UL resources is allowed to use.

In some embodiments, the method further comprises transmitting, to the RAN node, an indication of which configured group-shared UL resources that have been scheduled to which at least one UE within the group of UEs.

In some embodiments, the received configuration configuring the coordinator UE with group-shared UL resources is using one of DCI, Media Access Control (MAC) Control Element (CE), and Radio Resource Control (RRC) signalling.

In some embodiments, the received configuration configuring the coordinator UE with group-shared UL resources is addressed to the coordinator UE and comprises a group index indicating the group of UEs. The received configuration may be addressed to a Radio Network Temporary Identifier (RNTI) of the coordinator UE.

In some embodiments, the received configuration configuring at least the coordinator UE with group-shared UL resources is addressed to at least one UE within the group of UEs and comprises a group index indicating the group of UEs.

In some embodiments, the received configuration configuring at least the coordinator UE with group-shared UL resources is addressed to the group of UEs and comprises a group index indicating the group of UEs. The received configuration may be addressed to a group RNTI.

According to a second aspect, there is provided a method in a RAN node for scheduling and/or allocating resources for a group of UEs in a wireless communications system.

The method comprises transmitting, to a coordinator UE, a configuration configuring at least the coordinator UE with group-shared UL resources and SL resources to be used by the group of UEs. The configuration further indicates that the coordinator UE coordinates scheduling of the group-shared UL resources.

In some embodiments, the method further comprises transmitting, to at least one UE within the group of UEs, the configuration configuring the at least one UE within the group of UEs with group-shared UL resources and SL resources to be used by the group of UEs. The configuration further indicates that the coordinator UE coordinates scheduling of the group-shared UL resources.

In some embodiments, the method further comprises receiving, from the coordinator UE, a request for additional group-shared UL resources. The method further comprises transmitting, to at least the coordinator UE, a configuration configuring additional group-shared UL resources as a response to said received request for additional group-shared UL resources.

In some embodiments, the received request for additional group-shared UL resources comprises an indication of an amount of desired group-shared UL resources.

In some embodiments, the received request for additional group-shared UL resources comprises an aggregated BSR and the aggregated BSR comprises information of a total buffer status of all UEs within the group of UEs. The aggregated BSR may comprise an identifier indicating that the aggregated BSR is an aggregated BSR.

In some embodiments, the transmitted configuration configuring at least the coordinator UE with group-shared UL resources is using one of DCI, MAC CE, and RRC signalling.

In some embodiments, the transmitted configuration configuring the coordinator UE with group-shared UL resources is addressed to the coordinator UE and comprises a group index indicating the group of UEs. The transmitted configuration may be addressed to a RNTI of the coordinator UE.

In some embodiments, the transmitted configuration configuring at least the coordinator UE with group-shared UL resources is addressed to at least one UE within the group of UEs and comprises a group index indicating the group of UEs.

In some embodiments, the transmitted configuration configuring at least the coordinator UE with group-shared UL resources is addressed to the group of UEs and comprises a group index indicating the group of UEs. The transmitted configuration may be addressed to a group RNTI.

In some embodiments, the method further comprises receiving, from the coordinator UE, an indication of which configured group-shared UL resources that have been scheduled to which at least one UE within the group of UEs.

In some embodiments, the method further comprises identifying the coordinator UE.

According to a third aspect, there is provided a method in a UE within a group of UEs for receiving resources scheduled for the group of UEs in a wireless communications system.

The method comprises receiving, from a RAN node or from a coordinator UE, a configuration configuring the UE with SL resources to be used by the group of UEs, and configuring the UE that the coordinator UE coordinates scheduling of group-shared UL resources.

In some embodiments, the method further comprises transmitting via the SL resource, to the coordinator UE, a BSR.

In some embodiments, the method further comprises receiving, from the RAN node, allocation of group-shared UL resources.

In some embodiments, the method further comprises receiving, from the coordinator UE, allocation of group-shared UL resources.

In some embodiments, the allocation of group-shared UL resources comprises an indication of which group-shared UL resources to use. Which group-shared UL resources the UE is allowed to use may be indicated by a timing of a configured grant for said group-shared UL resources. Alternatively, the indication of which group-shared UL resources to use may be indicated by a polling chart, which informs the UE when the group-shared UL resources is allowed to use.

In some embodiments, the step of receiving allocation of group-shared UL resources comprises receiving a DCI using a configured search space on PDCCH.

In some embodiments, the received allocation of group-shared UL resources is received using one of DCI, MAC CE and RRC signalling.

In some embodiments, the received allocation of group-shared UL resources is addressed to the group of UEs. The received allocation of group-shared UL resources comprises a group index indicating the group of UEs. The received allocation may be addressed to a group RNTI.

In some embodiments, the received allocation of group-shared UL resources is addressed to the UE. The received allocation of group-shared UL resources comprises a group index indicating the group of UEs.

In some embodiments, the method further comprises receiving an indication identifying the coordinator UE.

According to a fourth aspect, there is provided a coordinator UE configured to perform the method according to the first aspect.

The coordinator UE is configured for scheduling resources for a group of UEs in a wireless communications system. The coordinator UE comprises a processing circuitry and a memory circuitry. The memory circuitry storing computer program code which, when run in the processing circuitry, causes the coordinator UE to receive, from a RAN node, a configuration configuring at least the coordinator UE with group-shared UL resources and SL resources to be used by the group of UEs. The configuration further indicates that the coordinator UE coordinates scheduling of the group-shared UL resources. The coordinator UE is further caused to monitor a demand for the group-shared UL resources by at least one UE within the group UEs. Based on the monitored demand for the group-shared UL resources, the coordinator UE is caused to schedule the configured group-shared UL resources to at least one UE within the group of UEs.

In some embodiments, the coordinator UE is configured to monitor the demand for the group-shared UL resources by receiving, via the SL resources, a BSR from at least one UE within the group of UEs.

In some embodiments, the coordinator UE is configured to monitor the demand for the group-shared UL resources by monitoring a sum of requested resources in at least one BSR from at least one UE within the group of UEs. If the sum of requested resources in said at least one BSR exceeds the configured group-shared UL resources, the coordinator UE transmits, to the RAN node, a request for additional group-shared UL resources.

In some embodiments, the request for additional group-shared UL resources comprises an indication of an amount of desired group-shared UL resources based on said sum of requested resources in said at least one BSR.

In some embodiments, the request for additional group-shared UL resources comprises an aggregated BSR and the aggregated BSR comprises information of a total buffer status of all UEs within the group of UEs. The aggregated BSR may comprise an identifier indicating that the aggregated BSR is an aggregated BSR.

In some embodiments, the coordinator UE is further caused to receive, from the RAN node, a configuration configuring additional group-shared UL resources as a response to said transmitted request for additional group-shared UL resources. The coordinator UE may further be caused to allocate partial or all the received additional group-shared UL resources to at least one UE within the group of UEs that has data to transmit.

In some embodiments, the coordinator UE is further caused to transmit, to the group of UEs, a configuration configuring the group of UEs with the SL resources to be used by the group of UEs and configuring the group of UEs that the coordinator UE coordinates the use of the group-shared UL resources.

In some embodiments, the coordinator UE is caused to schedule the configured group-shared UL resources to at least one UE within the group of UEs by indicating to the at least one UE within the group of UEs which group-shared UL resources to use.

In some embodiments, which group-shared UL resources the at least one UE within the group of UEs is allowed to use is indicated to said UE by indicating a timing of a configured grant for said group-shared UL resources.

In some embodiments, the coordinator UE is caused to indicate to the at least one UE within the group of UEs which group-shared UL resources to use by transmitting, to said at least one UE within the group of UEs, a DCI, using a configured search space on PDCCH.

In some embodiments, which group-shared UL resources the at least one UE within the group of UEs is allowed to use is indicated to said UE by a polling chart, which informs said UE when the group-shared UL resources is allowed to use.

In some embodiments, the coordinator UE is further caused to transmit, to the RAN node, an indication of which configured group-shared UL resources that have been scheduled to which at least one UE within the group of UEs.

In some embodiments, the received configuration configuring the coordinator UE with group-shared UL resources is using one of DCI, MAC CE, and RRC signalling.

In some embodiments, the received configuration configuring the coordinator UE with group-shared UL resources is addressed to the coordinator UE. The received configuration comprises a group index indicating the group of UEs. The received configuration may be addressed to a RNTI of the coordinator UE.

In some embodiments, the received configuration configuring the coordinator UE with group-shared UL resources is addressed to at least one UE within the group of UEs. The received configuration comprises a group index indicating the group of UEs.

In some embodiments, the received configuration configuring the coordinator UE with group-shared UL resources is addressed to the group of UEs. The received configuration comprises a group index indicating the group of UEs. The received configuration may be addressed to a group RNTI.

According to a fifth aspect, there is provided a RAN node configured to perform the method according to the second aspect.

The RAN node is configured for scheduling and/or allocating resources for a group of UEs in a wireless communications system. The RAN node comprises a processing circuitry and a memory circuitry. The memory circuitry storing computer program code which, when run in the processing circuitry, causes the RAN node to transmit, to a coordinator UE, a configuration configuring at least the coordinator UE with group-shared UL resources and SL resources to be used by the group of UEs. The configuration further indicates that the coordinator UE coordinates scheduling of the group-shared UL resources.

In some embodiments, the RAN node is further caused to transmit, to at least one UE within the group of UEs, the configuration configuring the at least one UE within the group of UEs with group-shared UL resources and SL resources to be used by the group of UEs. The configuration further indicates that the coordinator UE coordinates scheduling of the group-shared UL resources.

In some embodiments, the RAN node is further caused to receive, from the coordinator UE, a request for additional group-shared UL resources. The RAN node is further caused to transmit, to at least the coordinator UE, a configuration configuring additional group-shared UL resources as a response to said request for additional group-shared UL resources.

In some embodiments, the received request for additional group-shared UL resources comprises an indication of an amount of desired group-shared UL resources.

In some embodiments, the received request for additional group-shared UL resources comprises an aggregated BSR and the aggregated BSR comprises information of a total buffer status of all UEs within the group of UEs. The aggregated BSR may comprise an identifier indicating that the aggregated BSR is an aggregated BSR.

In some embodiments, the transmitted configuration configuring at least the coordinator UE with group-shared UL resources is using one of DCI, MAC CE and RRC signalling

In some embodiments, the transmitted configuration configuring the coordinator UE with group-shared UL resources is addressed to the coordinator UE. The received configuration comprises a group index indicating the group of UEs.

In some embodiments, the transmitted configuration configuring the coordinator UE with group-shared UL resources is addressed to the coordinator UE. The received configuration comprises a group index indicating the group of UEs. The transmitted configuration may be addressed to a RNTI of the coordinator UE.

In some embodiments, the transmitted configuration configuring at least the coordinator UE with group-shared UL resources is addressed to at least one UE within the group of UEs. The received configuration comprises a group index indicating the group of UEs. The transmitted configuration may be addressed to a group RNTI.

In some embodiments, the RAN node is further caused to receive, from the coordinator UE, an indication of which configured group-shared UL resources that have been scheduled to which at least one UE within the group of UEs.

In some embodiments, the RAN node is further caused to identify the coordinator UE.

According to a sixth aspect, there is provided a UE within a group of UEs configured to perform the method according to the third aspect.

The UE is configured for receiving resources scheduled for the group of UEs in a wireless communications system. The UE node comprises a processing circuitry and a memory circuitry. The memory circuitry storing computer program code which, when run in the processing circuitry, causes the UE to receive, from a RAN node or from a coordinator UE, a configuration configuring the UE with SL resources to be used by the group of UEs, and configuring the UE that the coordinator UE coordinates scheduling of group-shared UL resources.

In some embodiments, the UE is further caused to transmit via the SL resource, to the coordinator UE, a BSR.

In some embodiments, the UE is further caused to receive, from the RAN node allocation of group-shared UL resources.

In some embodiments, the UE is further caused to receive, from the coordinator UE, allocation of group-shared UL resources.

In some embodiments, the allocation of group-shared UL resources comprises an indication of which group-shared UL resources to use.

In some embodiments, which group-shared UL resources the UE is allowed to use is indicated by a timing of a configured grant for said group-shared UL resources. In other embodiments, the indication of which group-shared UL resources to use is indicated by a polling chart, which informs the UE when the group-shared UL resources is allowed to use.

In some embodiments, the UE is further caused to receive a DCI using a configured search space on PDCCH.

In some embodiments, the received allocation of group-shared UL resources is received using one of DCI, MAC CE and RRC signalling.

In some embodiments, the received allocation of group-shared UL resources is addressed to the group of UEs. The received allocation of group-shared UL resources comprises a group index indicating the group of UEs. The received allocation of group-shared UL resources may be addressed to a group RNTI

In some embodiments, the received allocation of group-shared UL resources is addressed to the UE. The received allocation of group-shared UL resources comprises a group index indicating the group of UEs.

In some embodiments, the UE is further caused to receive an indication identifying the coordinator UE.

According to a seventh aspect, there is provided a computer program, comprising instructions which, when executed on a processing circuitry, cause the processing circuitry to carry out the method according to the first aspect, the second aspect and/or the third aspect.

According to an eight aspect, there is provided a carrier containing the computer program of the seventh aspect, wherein the carrier is one of an electronic signal, optical signal, radio signal, or computer readable storage medium.

The various proposed embodiments herein provide a solution for enhancing scheduling of UL resources in order to reduce latency and processing loads in situations where many UEs may transmit data. This is achieved by providing methods and apparatuses applicable for a group of UEs within a wireless communications system where a coordinator UE monitors and coordinates the scheduling of group-shared UL resources within the group of UEs.

### BRIEF DESCRIPTION OF THE DRAWINGS

These and other aspects, features and advantages will be apparent and elucidated from the following description of various embodiments, reference being made to the accompanying drawings, wherein:

FIG. 1 illustrates a NR physical resource grid;

FIG. 2a shows dynamic scheduling in LTE/NR;

FIG. 2b illustrates the delay for an NR MBB scenario for a small data upload;

FIG. 3 is a message sequence chart of a process for group transmissions in a wireless communications system;

FIG. 4a is a flowchart of an example method performed by a coordinator UE;

FIG. 4b illustrates a legacy situation of configured grants;

FIG. 4c illustrates configured grants according to an embodiment;

FIG. 4d illustrates an example of a dynamic grant;

FIG. 5 is a flowchart of an example method performed by a RAN node;

FIG. 6 is a flowchart of an example method performed by a UE;

FIG. 7 shows an example implementation of a coordinator UE;

FIG. 8 shows an example implementation of a RAN node;

FIG. 9 shows an example implementation of a coordinator UE;

FIG. 10 illustrates an example wireless network;

FIG. 11 shows a user equipment according to an embodiment;

FIG. 12 shows a virtualization environment according to an embodiment;

FIG. 13 illustrates an example telecommunication network connected via an intermediate network to a host computer;

FIG. 14 shows a host computer communicating via a base station with a user equipment over a partially wireless connection according to an embodiment;

FIGS. 15 and 16 show example methods implemented in a communication system including a host computer, a base station and a user equipment; and

FIGS. 17 and 18 show example methods implemented in a communication system including a host computer, a base station and a user equipment.

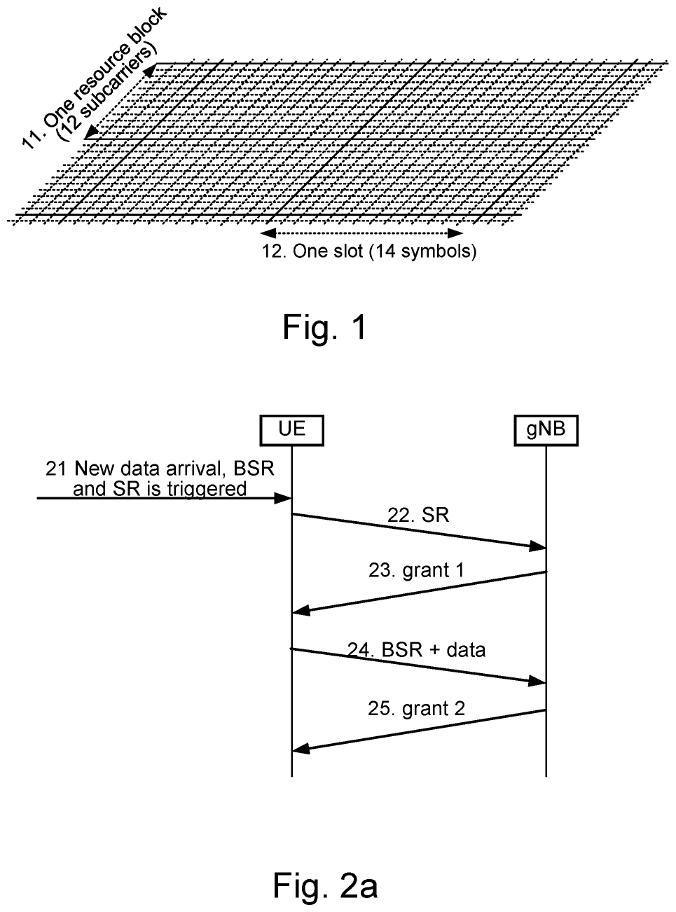

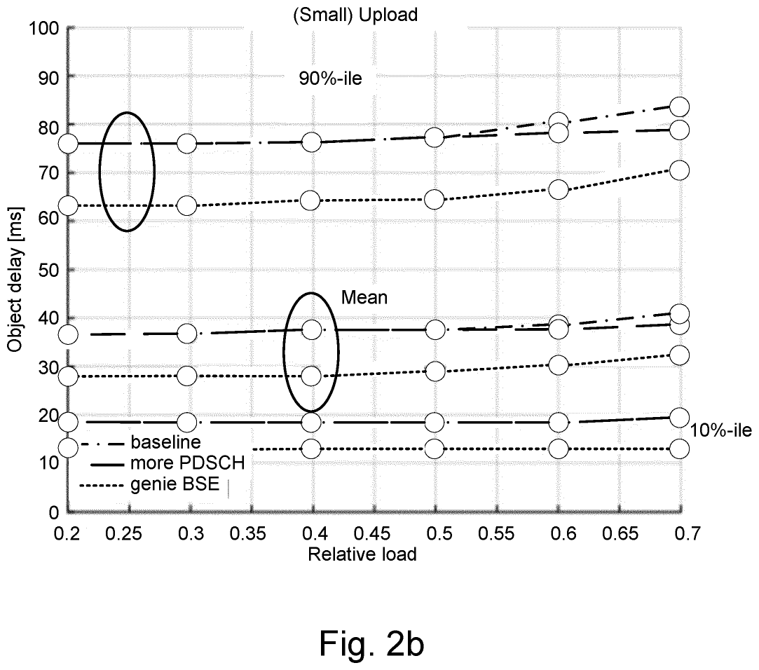

### DETAILED DESCRIPTION

The present invention will now be described more fully hereinafter. The present invention may, however, be embodied in many different forms and should not be construed as limited to the embodiments set forth herein; rather, these embodiments are provided by way of example so that this disclosure will be thorough and complete, and will fully convey the scope of the invention to those persons skilled in the relevant art. Like reference numbers refer to like elements throughout the description.

The present disclosure relates to methods and apparatuses applicable for a group of User Equipment (UEs), which may communicate over SideLink (SL). In this group of UEs, there is a coordinator UE. The coordinator UE is configured by a Radio Access Network (RAN) node, such as a base station, eNB or gNB, to perform scheduling of UEs within the group of UEs on behalf of the RAN node. In some embodiments, the coordinator UE may have different capabilities than ordinary UEs within the group of UEs, e.g., a higher processing capability. In other embodiments, the coordinator UE may have the same capabilities as the ordinary UEs within the group of UEs as long as the UE supports the required functionalities. Alternatively, the coordinator UE may be a dedicated network entity that coordinates the resources within the group of UEs.

In one of its aspects, the disclosure presented herein concerns a method in the coordinator UE for scheduling resources for the group of UEs in the wireless communications system.

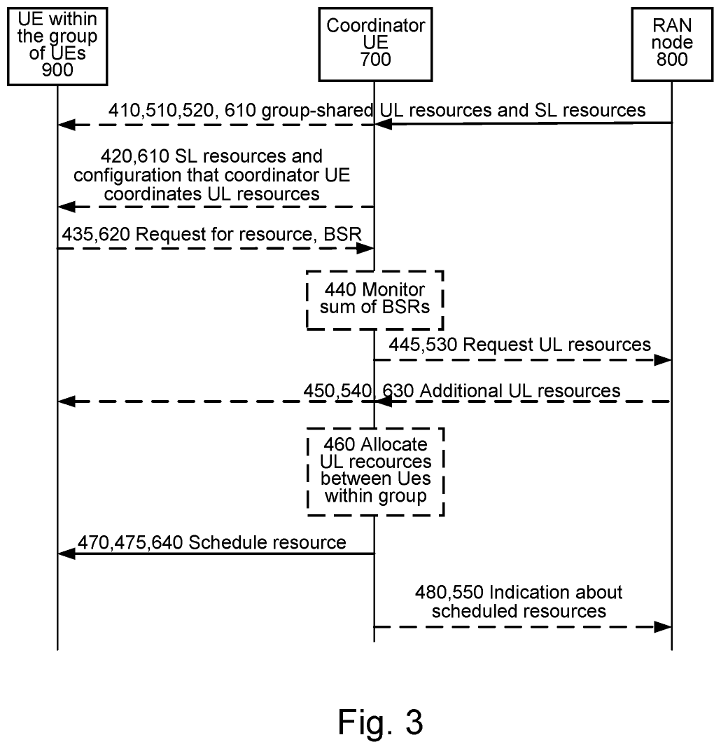

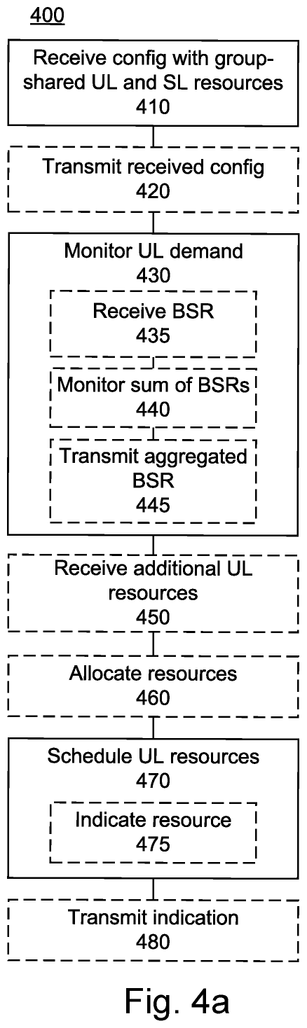

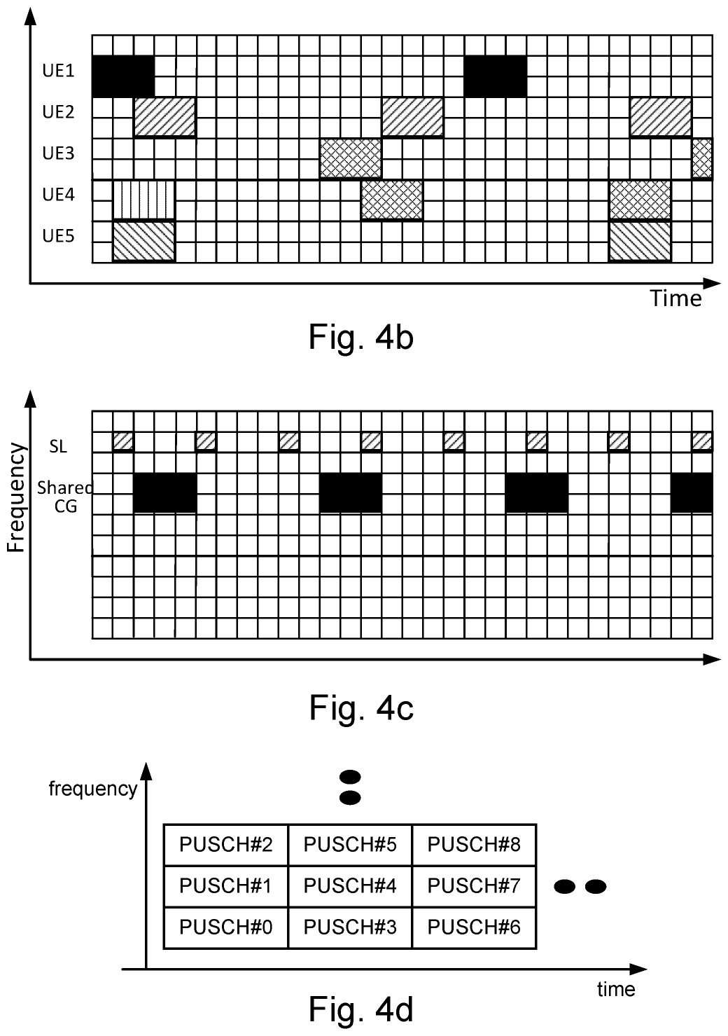

With reference to the FIGS. 3 and 4a, a first embodiment will now be described. FIG. 3 illustrates a message sequence chart of a process for scheduling resources for a group of UEs in a wireless communications system. FIG. 4a illustrates a method 400 in a coordinator UE 700 for scheduling resources for a group of UEs in a wireless communications system. The group of UEs comprises a plurality of UEs. The group of UEs may be formed considering at least one of the following conditions; similar traffic patterns, located in the same proximity, similar UE capabilities, similar mobility status, similar resource demands and same priority or reliability traffic. The coordinator UE 700 is selected to operate as the coordinator of the resources for its group of UEs. The coordinator UE 700 may have been selected considering at least one of: strongest radio channel quality, location relative the group centre, support the least required buffer size which meets the requirements for the group communication and the least channel variations, which may be estimated from past time window of history channel reporting. The coordinator UE 700 may represent the group of UEs in communications with a RAN node 800 regarding group resource scheduling. The RAN node 800 may optionally has knowledge of which UEs are in the groups of UEs and which UE that is the coordinator UE 700. The coordinator UE 700 may alternatively, or additionally, be responsible for forwarding or aggregating Scheduling Requests (SRs) and Buffer Status Reports (BSRs) for the group of UEs to the RAN node 800, and scheduling group resources, which are assigned and/or scheduled by the RAN node 800 to the group of UEs.

As illustrated in FIGS. 3 and 4a, the method 400 begins with step 410 of receiving, from a RAN node 800, a configuration configuring at least the coordinator UE 700 with group-shared UpLink (UL) resources and SL resources to be used by the group of UEs. The configuration received from the RAN node 800 further indicates that the coordinator UE 700 coordinates scheduling of the group-shared UL resources. Thus, the RAN node 800 configures two sets of resources for the group of UEs.

The group-shared UL resources are resources for transmitting data from a UE to the RAN node 800. The size and frequency of the initially received group-shared UL resources are sufficient to transmit at least smaller amounts of data. The group-shared UL resources may comprise, for example, a group-shared dynamic grant, or a set of group-shared dynamic grants, which may have a valid period that spans multiple slots or OFDM symbols in time domain, consecutive or not consecutive. Alternatively, the group-shared UL resources may comprise group-shared configured grants. Licensed spectrum may be used for the group-shared UL resources, but alternatively, the group-shared UL resources may optionally comprise resources partly or fully in unlicensed spectrum.

The received SL resources are resources for transmitting data between the coordinator UE 700 and the UEs 900 within the group of UEs. The SL resources may be used for transmitting data from the coordinator UE 700 to the UEs within the group of UEs, and the SL resources may be used for transmitting data to the coordinator UE 700 from the UEs within the group of UEs. The size of the SL resources may be enough to receive Buffer Status Reports (BSRs) from the UEs 900 within the group of UEs to the coordinator UE 700. Additionally, the SL resources may be used for transmitting data between the UEs 900 within the group. The frequency may be high to keep scheduling low.

In some embodiments, the method 400 may further comprise step 420 of transmitting, to the group of UEs, a configuration configuring the group of UEs with the SL resources to be used by the group of UEs and configuring the group of UEs that the coordinator UE 700 coordinates the use of the group-shared UL resources.

The method 400 thereafter continues with step 430 of monitoring a demand for the group-shared UL resources by at least one UE 900 within the group of UEs. Accordingly, the group-shared UL resources are coordinated by the coordinator UE 700. The demand for the group-shared UL resources comprises the demand for UL resources by one or more UEs 900 within the group of UEs. Thereafter, based on the monitored demand for the group-shared UL resources, the method 400 continues with step 470 of scheduling the configured group-shared UL resources to at least one UE 900 within the group of UEs. For example, a grant may be given to the at least one UE 900 within the group of UEs for UL PUSCH, based on already received group-shared UL resources.

Accordingly, the present disclosure provides an improved way for scheduling UL resources, which may be shared between a group of UEs. By providing a method 400 where a coordinator UE 700 monitors and/or schedules group-shared UL resources within the group of UEs, the coordinator UE 700 controls which at least one UE 900 within the group of UEs that may use the configured group-shared UL resources. Latency and processing loads may be reduced, and there may be a shorter delay for assigned UL resources. Furthermore, there may be less SR and BSR signalling to the RAN node 800.

The configured group-shared UL resources may be scheduled or assigned to the UEs 900 within the group of UEs in different ways. According to one embodiment, the coordinator UE 700 may schedule group dynamic grants within the group of UEs. A UE 900 within the group of UEs that has data available may have to send a SR/BSR to the coordinator UE 700. Upon reception of the SR/BSR from the UE 900, the coordinator UE 700 may schedule one or multiple grants to said UE 900. According to another embodiment, a UE 900 within the group of UEs may select a group-shared UL resource, i.e. a grant from the set of the group grants, in a contention-based manner. In this embodiment, there may be collisions if more than one UE 900 within the group of UEs selects the same grant. To overcome transmission failures due to a collision, a UE 900 may perform autonomous retransmissions for a TB, wherein the retransmissions may be a repetition of the previous transmission or a transmission with incremental redundancy with respects to one of the previous transmissions containing the information. Alternatively, a Clear Channel Assessment (CCA) or a Listen Before Talk (LBT) mechanism may be applied by the UE 900 to determine if a specific grant is being occupied by another UE. According to still another embodiment, there may be a mapping relation configured between the UEs 900 within the group of UEs and the configured group-shared UL resources, i.e. the dynamic grants. The mapping relation may be reconfigured by the coordinator UE 700 and/or the RAN node 800 from time to time. In this embodiment, each UE 900 within the group of UEs may know which PUSCH is assigned to it based on the mapping relation.

In some embodiments, the step 430 of monitoring the demand for the group-shared UL resource may comprise step 435 of receiving, via the SL resources, a Buffer Status Report (BSR) from at least one UE 900 within the group of UEs. A Sidelink Control Information (SCI) may be used to inform the coordinator UE 700 of the source/transmitting UE 900. Accordingly, it may be possible to monitoring the demand for group-shared UL resources, as BSRs may be received from the UEs 900 within the group of UEs. Thus, less SR and BSR signalling to the RAN node 800 may be needed. The UEs 900 within the group of UEs may use legacy channel sensing to avoid collisions when using the group-shared SL resources for transmitting BSRs to the coordinator UE 700. The step 430 of monitoring the demand for the group-shared UL resource may additionally, or alternatively, further comprise step 440 of monitoring a sum of requested resources for example in at least one BSR from at least one UE 900 within the group of UEs or the frequency of the BSRs from different UEs which may be an indication that the previously scheduled resources to these UEs are not enough. If more resources are needed, additional group-shared UL resources may be requested from the RAN node 800. For example, if the sum of the requested resources in said at least one BSR exceeds the configured group-shared UL resources, the method 400 may further comprise the step 445 of transmitting, to the RAN node 800, a request for additional group-shared UL resources. Thus, the buffer status of the UEs 900 within the group of UEs may be tracked, and if already configured group-shared UL resources are not enough to cater for the needs of the group of UEs, a request for additional resources may be transmitted to the RAN node 800.

By receiving BSRs from the UEs 900 within the group of UEs, the coordinator UE 700 may monitor the demand for the group-shared UL resources by the group of UEs. This may allow a denser group-shared UL resource configuration without wasting resources and may allow low latency transmissions. This is illustrated with reference to FIGS. 4b and 4c. In a legacy situation, all UEs may be configured with dedicated UL resources, illustrated in FIG. 4b. As seen in FIG. 4b, this may require a large amount of resources to be configured. FIG. 4c shows an example of the proposed configuration of group-shared UL resources and SL resources. As seen in FIG. 4c, only small resources on the SL is used for BSR transmissions to the coordinator UE 700. The coordinator UE 700 may then schedule the UEs 900 within the group of UEs on the group-shared UL resources, which in the illustrated example embodiment is a shared configured grant resource. As seen, in case the load on the configured grant is relatively low, large resource savings may be allowed in terms of configured resources. Depending on what the corresponding legacy configuration would have been for a specific UE, the latency may be even lowered. Furthermore, the UEs 900 within the group of UEs that have data to transmit may start by sending a BSR on the SL resource to the coordinator UE 700. The coordinator UE 700 may then schedule the UE 900 on the first available shared configured grant resource. Since the scheduling is controlled by the coordinator UE 700, no collisions on the group-shared UL resource will happen.

The request for additional group-shared UL resources transmitted in step 445 may comprise, according to some embodiments, an indication of an amount of desired group-shared UL resources based on said sum of requested resources in said at least one BSR. The request for additional group-shared UL resources may comprise, for example, an aggregated BSR and the aggregated BSR may comprise information of a total buffer status of all UEs 900 within the group of UEs. Additionally, the request for additional group-shared UL resource may comprise information about the numbers of UEs 900 within the group of UEs that are having data to transmit. The number of UEs 900 having data to transmit is most likely a subset of the group of UEs.

In some embodiments, the aggregated BSR may comprise an identifier indicating that the aggregated BSR is an aggregated BSR. The aggregated BSR may be, according to some embodiments, aggregated by the coordinator UE 700 based on a priority of the UE 900 within the group of UEs that has data to transmit. In such embodiments, BSRs belonging to a common priority may be aggregated and these aggregated BSR, belonging to different priorities, may be reported to the RAN node 800.

As a response to said transmitted request for additional resourced, the method 400 may further comprise step 450 of receiving, from the RAN node 800, a configuration configuring additional group-shared UL resources. Thus, the coordinator UE 700 may receive a new “big” grant from the RAN node 800. This big grant may be an extension, reconfiguration, of the current configured group-shared UL resources, i.e. allowing higher bit rate, or dynamic grants for a UE 900 within the group of UEs. The received configuration configuring additional group-shared UL resources may be distributed over the resource map in order to reduce interference, e.g. the RAN node 800 may know that this is intended for a group of UEs that possibly may be located near each other.

Additionally, the method 400 may further comprise step 460 of allocating partial or all the received additional group-shared UL resources to at least one UE 900 within the group of UEs that has data to transmit. If the received configuration configuring group-shared UL resources comprises a dynamic grant, the grant may be split up into several grants to several of the UEs within the group of UEs based on earlier received BSRs from the UEs 900 within the group of UEs. Alternatively, the received configuration configuring group-shared UL resources may comprise several grants, according to information in the transmitted request for additional group-shared UL resources, e.g. according to information in the aggregated BSR, which may be distributed to the different UEs 900 within the group of UEs by the coordinator UE 700.

In some embodiments, the step 470 of scheduling the configured group-shared UL resources to at least one UE 900 within the group of UEs may comprises step 475 of indicating to the at least one UE 900 within the group of UEs which group-shared UL resources to use. In this way, which at least one UE 900 within the group of UEs that may use the group-shared UL resources may be controlled by the coordinator UE 700. For example, which group-shared UL resources the at least one UE 900 is allowed to use may be indicated to said UE 900 by indicating a timing of a configured grant for said group-shared UL resources. Alternatively, or additionally, the step 475 of indicating to the at least one UE 900 which group-shared UL resources to use may comprise step 480 of transmitting, to said at least one UE 900, a Downlink Control Information (DCI) using a configured search space on Physical Sidelink Common Control Channel (PDCCH). As an alternative, SL SCI may be used on Physical Sidelink Common Control Channel (PSCCH)/Physical Sidelink Shared Channel (PSSCH).

In an alternative embodiment, which group-shared UL resources the at least one UE 900 within the group of UEs is allowed to use may be indicated to said UE 900 by a polling chart, which informs said UE 900 when the group-shared UL resources is allowed to use. Whenever a UE 900 within the group of UEs may have data in their buffer and intend to transmit on the group-shared UL resources, e.g. configured grants, the coordinator UE 700 may prepare a polling chart, and the UE 900 within the group of UEs may transmit according to their turn or polling. The UEs 900 within the group of UEs may be informed about the polling information (command) via SL channels via broadcast/multicast or via unicast. I.e., if the UEs 900 within the group of UEs are informed via broadcast, they are informed via a single message comprising the polling information of the UEs 900 within the group of UEs. Alternatively, if they are informed via unicast, an individual UE 900 within the group of UEs may know about its turn (allocation) only regarding the transmission in the shared CG period. An individual UE 900 within the group of UEs may send a request to the coordinator UE 700 for better polling. Depending on the allocation, the coordinator UE 700 may update the polling information. In case there are not enough resources, the coordinator UE 700 may send a request to the RAN node 800 to update the group-shared UL resources, i.e. configured grants, to meet the group demand. In the polling information, or command, the coordinator UE 700 may also provide other information, e.g., repetitions per UE. The number of repetitions per UE may be different for different UEs and may be influenced, e.g., by the UE's traffic priority or reliability requirement. Other information that may be provided may be Redundancy Version (RV) pattern, and Modulation and Coding Schemes (MCS). According to one embodiment, prioritized UEs may be allowed to transmit first, in the queue, in the period, or with larger repetitions, occasions.

According to some embodiments, the method 400 may further comprise step 480 of transmitting, to the RAN node 800, an indication of which configured group-shared UL resources that have been scheduled to which at least one UE 900 within the group of UEs. The indication may include, for example, some serial number associating the transmitting UE 900 within the group of UEs and data packets. This information may be transmitted simultaneously as the group-shared UL resources are scheduled to the at least one UE 900 within the group of UEs. Due to this option, the RAN node 800 may not have to perform blind decoding when data is received from the at least one UE 900 within the group of UEs, as the RAN node 800 then may have information about which at least one UE 900 that will use the configured group-shared UL resources. According to other embodiments, information about the scheduled group-shared UL resources to the at least one UE 900 within the group of UEs may be broadcasted in a report, which both said at least one UE 900 and the RAN node 800 may read.

In some embodiments, the received configuration configuring the coordinator UE 700 with group-shared UL resources may be using one of DCI, Media Access Control (MAC) Control Element (CE) and Radio Resource Control (RRC) signaling. The received configuration configuring the coordinator UE 700 with group-shared UL resources may be, for example, addressed to the coordinator UE 700 and comprise a group index indicating the group of UE. The group index may be a unique group index and may be used to identify the group of UEs. The received configuration may be addressed to a Radio Network Temporary Identifier (RNTI) of the coordinator UE, such as the coordinator UE's C-RNTI. If the group-shared UL resources comprises dynamic grants, the group-shared UL resources may be signaled by the RAN node 800 using one single DCI. Thus, the RAN node 800 may allocate a group or a chunk of group-shared UL resources to the coordinator UE 700, which may only be seen by the coordinator UE 700. The coordinator UE 700 may then split and distribute the group-shared UL resources to the individual UEs 900 within the group of UEs. Alternatively, the received configuration configuring at least the coordinator UE 700 with group-shared UL resources may be addressed to at least one UE 900 within the group of UEs and comprise a group index indicating the group of UEs. Thus, the group-shared UL resources may be allocated to individual UEs within the group of UEs by the RAN node 800 and this information may be forwarded directly to the individual UEs by the RAN node 800. In still an alternative embodiment, the received configuration configuring at least the coordinator UE 700 with group-shared UL resources may be addressed to the group of UEs and comprise a group index indicating the group of UEs. The received configuration may be addressed to a group RNTI, such as a group C-RNTI. The received group-shared UL resources may then be visible to all UEs 900 within the group of UEs. The allocations to individual UEs within the group of UEs may be done by the RAN node 800, but this information may be forwarded to the individual UEs by the coordinator UE 700.

For any of the above options, if the group index is carried in the DCI, a bitmap field may be added in the DCI in order to reduce the control signalling overhead. The size of the bitmap may be equal to the number of configured groups of UEs. Each position in the bitmap field, i.e. i-th bit, may correspond to a specific group associated with the index i.

In case the group-shared UL resources comprise dynamic grants, the dynamic grants may indicate multiple PUSCHs spanning in both frequency domain and time domain. Each PUSCH may span y Physical Resource Blocks (PRBs)/sub carriers in frequency and z OFDM symbols in time. An example of the dynamic grant is illustrated in FIG. 4d. Among the PUSCHs allocated by the group dynamic grants, each PUSCH may have a different PUSCH duration, MCS, and K2 value. These PUSCHs may be located in the frequency domain and/or time domain consecutively or non-consecutively.

Thus, the various proposed embodiments herein provide a solution for enhancing scheduling of UL resources in order to reduce latency and processing loads in situations where many UEs may transmit data.

According to a second aspect of the present disclosure, there is provided a method 500 in a RAN node 800 for scheduling and/or allocating resources for a group of UEs in a wireless communications system.

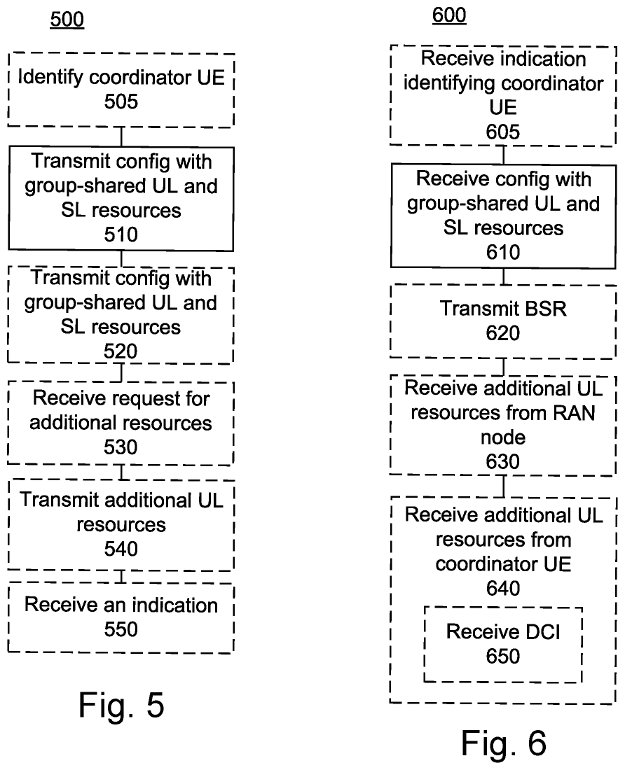

With reference to the FIGS. 3 and 5, a first embodiment will now be described. As stated above, FIG. 3 is a message sequence chart of a process for group transmissions in a wireless communications system. FIG. 5 illustrates a method 500 in a RAN node 800 for group transmissions in a wireless communications system.

As illustrated in FIG. 5, the method 500 comprises step 510 of transmitting, to a coordinator UE 700, a configuration configuring at least the coordinator UE 700 with group-shared UL resources and SL resources to be used by the group of UEs. The configuration further indicates that the coordinator UE 700 coordinates scheduling of the group-shared UL resources, scheduling of which may be controlled by the coordinator UE 700. Thus, the present disclosure provides a solution for enhancing scheduling of UL resources in order to reduce latency and processing loads in situations where many UEs may transmit data.

In some embodiments, the method 500 may further comprise step 505 of identifying the coordinator UE 700. One of the UEs within the group of UEs may be identified, or selected, to operate as the coordinator UE 700. According to some embodiments, the RAN node 800 may select which UE that may be the coordinator UE 700. The coordinator UE 700 may have been selected, or identified, considering at least one of: strongest radio channel quality, location relative the group centre and support the least required buffer size that meets the requirements for the group communication.

In some embodiments, the method 500 may further comprise step 520 of transmitting, to at least one UE 900 within the group of UEs, the configuration configuring the at least one UE 900 within the group of UEs with group-shared UL resources and SL resources to be used by the group of UEs. The configuration may optionally further indicate which UE that is the coordinator UE 700 coordinating scheduling of the group-shared UL resources. For example, the UE ID, or a temporary ID, of the coordinator UE 700 may be indicated to the UEs 900 within the group of UEs.

In some embodiments, the method 500 may further comprise step 530 of receiving, from the coordinator UE 700, a request for additional and/or new group-shared UL resources. The method 500 may further comprise step 540 of transmitting, to at least the coordinator UE 700, a configuration configuring additional and/or new group-shared UL resources as a response to said received request for additional group-shared UL resources. The received request for additional group-shared UL resources may comprise an indication of an amount of desired group-shared UL resources.

In some embodiments, the received request for additional group-shared UL resources may comprise an aggregated BSR and the aggregated BSR may comprise information of a total buffer status of all UEs 900 within the group of UEs. The aggregated BSR may comprise an identifier indicating that the aggregated BSR is an aggregated BSR.

In some embodiments, the transmitted configuration configuring at least the coordinator UE 700 with group-shared UL resources may be using one of DCI, MAC CE, and RRC signalling. According to one embodiment, the transmitted configuration configuring the coordinator UE 700 with group-shared UL resources may be addressed to the coordinator UE 700. The transmitted configuration may comprise a group index indicating the group of UEs. The transmitted configuration may be addressed to a RNTI of the coordinator UE 700. Alternatively, the transmitted configuration configuring at least the coordinator UE 700 with group-shared UL resources may be addressed to at least one UE 900 within the group of UEs. The transmitted configuration may comprise a group index indicating the group of UEs. In still an alternative embodiment, the transmitted configuration configuring at least the coordinator UE 700 with group-shared UL resources may be addressed to the group of UEs. The transmitted configuration may comprise a group index indicating the group of UEs. The transmitted configuration may be addressed to a group RNTI.

In some embodiments, the method 500 may further comprise step 540 of receiving, from the coordinator UE 700, an indication of which configured group-shared UL resources that have been scheduled to which at least one UE 900 within the group of UEs.

According to a third aspect of the present disclosure, there is provided a method 600 in a UE 900 within a group of UEs for receiving resources scheduled for the group of UEs in a wireless communications system.

With reference to the FIGS. 3 and 6, a first embodiment will now be described. As stated above, FIG. 3 is a message sequence chart of a process for group transmissions in a wireless communications system. FIG. 6 illustrates a method 600 in a UE 900 for group transmissions in a wireless communications system.

As illustrated in FIG. 6, the method 600 comprises step 610 of receiving, from a RAN node 800 or from a coordinator UE 700, a configuration configuring the UE 900 with SL resources to be used by the group of UEs, and configuring the UE 900 that the coordinator UE 700 coordinates scheduling of group-shared UL resources. Thus, the present disclosure provides a solution for enhancing scheduling of UL resources in order to reduce latency and processing loads in situations where many UEs may transmit data.

In some embodiments, the method 600 may further comprise step 605 of receiving an indication identifying the coordinator UE 700. The indication may identify which UE that is the coordinator UE 700 coordinating scheduling of the group-shared UL resources. For example, the UE ID, or a temporary ID, of the coordinator UE 700 may be indicated to the UE 900. The indication may be received from the coordinator UE 700 directly. Alternatively, the indication may be received from the RAN node 800.

In some embodiments, the method 600 may further comprise step 620 of transmitting via the SL resource, to the coordinator UE 700, a BSR. The method 600 further comprise step 630 of receiving, from the RAN node 800, allocation of group-shared UL resources. Alternatively, the method 600 may comprise step 640 of receiving, from the coordinator UE 700, allocation of group-shared UL resources. The allocation of group-shared UL resources may comprise an indication of which group-shared UL resources to use. Which group-shared UL resources the UE 900 is allowed to use may be indicated by a timing of a configured grant for said group-shared UL resources. Alternatively, the indication of which group-shared UL resources to use may be indicated by a polling chart, which informs the UE 900 when the group-shared UL resources is allowed to use.

In some embodiments, the step 640 of receiving allocation of group-shared UL resources may comprise receiving a DCI using a configured search space on PDCCH.

In some embodiments, the received allocation of group-shared UL resources is received using one of DCI, MAC CE and RRC signalling. The received allocation of group-shared UL resources may be addressed to the group of UEs and may comprise a group index indicating the group of UEs. The transmitted configuration may be, for example, addressed to a group RNTI. Alternatively, the received allocation of group-shared UL resources may be addressed to the UE 900 and may comprise a group index indicating the group of UEs.

According to a fourth aspect, there is provided a coordinator UE 700 configured to perform the method 400 according to the first aspect.

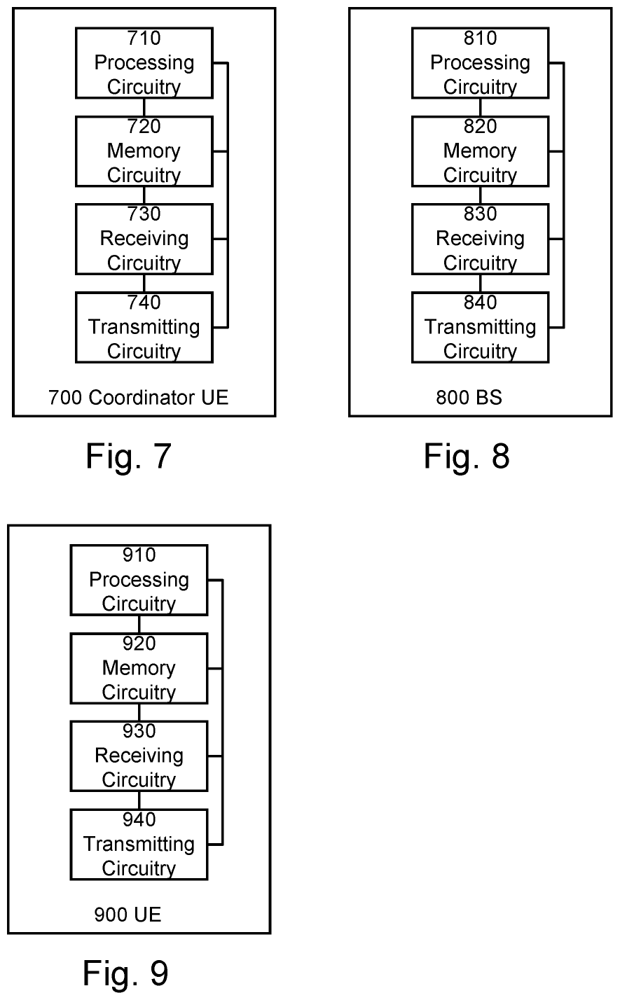

The coordinator UE 700 is now going to be described with reference to FIG. 7. The coordinator UE 700 may be used in, but are not limited to, a wireless communication system.

The coordinator UE 700 is configured for scheduling resources for a group of UEs in a wireless communications system. As illustrated in FIG. 7, the coordinator UE 700 comprises a processor, or a processing circuitry 710, and a memory, or a memory circuitry 720.

Additionally, or alternatively, the coordinator UE 700 may further comprise a transmitter, or a transmitting circuitry 740, configured to transmit data to other apparatuses, such as the RAN node 800 or at least one UE 900 within a group of UEs.

Additionally, or alternatively, the coordinator UE 700 may further comprise a receiver, or a receiving circuitry 730, configured to receive data from other apparatuses, such as the RAN node 800 or at least one UE 900 within a group of UEs.

The memory circuitry 720 stores computer program code which, when run in the processing circuitry 710, causes the coordinator UE 700 to receive, from a RAN node 800, a configuration configuring at least the coordinator UE 700 with group-shared UL resources and SL resources to be used by the group of UEs. The configuration further indicates that the coordinator UE 700 coordinates scheduling of the group-shared UL resources. The coordinator UE 700 is further caused to monitor a demand for the group-shared UL resources by at least one UE 900 within the group UEs and to schedule, based on the monitored demand for the group-shared UL resources, the configured group-shared UL resources to at least one UE 900 within the group of UEs.

Thus, the coordinator UE 700 according to the present disclosure enables enhanced scheduling of UL resources in order to reduce latency and processing loads in situations where many UEs may transmit data.

In some embodiments, the coordinator UE 700 may be configured to monitor the demand for the group-shared UL resources by receiving, via the SL resources, a BSR from at least one UE 900 within the group of UEs.

In some embodiments, the coordinator UE 700 may be configured to monitor the demand for the group-shared UL resources by monitoring a sum of requested resources in at least one BSR from at least one UE 900 within the group of UEs. If the sum of requested resources in said at least one BSR exceeds the configured group-shared UL resources, the coordinator UE may transmit, to the RAN node 800, a request for additional group-shared UL resources.

In some embodiments, the request for additional group-shared UL resources may comprise an indication of an amount of desired group-shared UL resources based on said sum of requested resources in said at least one BSR. Alternatively, or additionally, the request for additional group-shared UL resources may comprise an aggregated BSR and the aggregated BSR may comprise information of a total buffer status of all UEs 900 within the group of UEs. The aggregated BSR may comprise an identifier indicating that the aggregated BSR is an aggregated BSR.

In some embodiments, the coordinator UE 700 may further be caused to receive, from the RAN node 800, a configuration configuring additional group-shared UL resources as a response to said transmitted request for additional group-shared UL resources. The coordinator UE 700 may further be caused to allocate partial or all the received additional group-shared UL resources to at least one UE 900 within the group of UEs that has data to transmit.

In some embodiments, the coordinator UE 700 may further be caused to transmit, to the group of UEs, a configuration configuring the group of UEs with the SL resources to be used by the group of UEs and configuring the group of UEs that the coordinator UE 700 coordinates the use of the group-shared UL resources.

In some embodiments, the coordinator UE 700 may be caused to schedule the configured group-shared UL resources to at least one UE 900 within the group of UEs by indicating to the at least one UE 900 within the group of UEs which group-shared UL resources to use. Which group-shared UL resources the at least one UE 900 within the group of UEs is allowed to use may be indicated to said UE by, for example, indicating a timing of a configured grant for said group-shared UL resources. Alternatively, or additionally, the coordinator UE 700 may be caused to indicate to the at least one UE 900 within the group of UEs which group-shared UL resources to use by transmitting, to said at least one UE 900 within the group of UEs, a DCI, using a configured search space on PDCCH.

In some embodiments, which group-shared UL resources the at least one UE 900 within the group of UEs is allowed to use may be indicated to said UE 900 by a polling chart, which informs said UE 900 when the group-shared UL resources is allowed to use.

In some embodiments, the coordinator UE 700 may be further caused to transmit, to the RAN node 800, an indication of which configured group-shared UL resources that have been scheduled to which at least one UE 900 within the group of UEs.

In some embodiments, the received configuration configuring the coordinator UE 700 with group-shared UL resources may be using one of DCI, MAC CE, and RRC signalling. In some embodiments, the received configuration configuring the coordinator UE 700 with group-shared UL resources may be addressed to the coordinator UE 700 and may comprise a group index indicating the group of UEs. The received configuration may be addressed to a RNTI of the coordinator UE 700. Alternatively, the received configuration configuring the coordinator UE 700 with group-shared UL resources may be addressed to at least one UE 900 within the group of UEs and may comprise a group index indicating the group of UEs. Alternatively, the received configuration configuring the coordinator UE 700 with group-shared UL resources may be addressed to the group of UEs and may comprise a group index indicating the group of UEs. The received configuration may be addressed to a group RNTI.

According to an alternative embodiment, the coordinator UE 700 configured to perform the method 400 according to the first aspect may comprise a receiving unit, a monitoring unit and a scheduling unit. The receiving unit may be configured to receive, from a RAN node 800, a configuration configuring at least the coordinator UE 700 with group-shared UL resources and SL resources to be used by the group of UEs. The monitoring unit may be configured to monitor a demand for the group-shared UL resources by at least one UE 900 within the group of UEs. The scheduling unit may be configured to schedule, based on the monitored demand for the group-shared UL resources, the configured group-shared UL resources to at least one UE 900 within the group of UEs. The coordinator UE 700 may further comprise a transmitting unit, an allocating unit and an indicating unit.

According to a fifth aspect, there is provided a RAN node 800 for implementing the method 500 according to the second aspect.

The RAN node 800 is now going to be described with reference to FIG. 8. The RAN node 800 may be used in, but are not limited to, wireless communications system.

The RAN node 800 is configured for scheduling and/or allocating resources for a group of UEs in a wireless communications system. As illustrated in FIG. 8, the RAN node 800 comprises a processor, or a processing circuitry 810, and a memory, or a memory circuitry 820.

Additionally, or alternatively, the RAN node 800 may further comprise a transmitter, or a transmitting circuitry 840, configured to transmit data to other apparatuses, such as the coordinator UE 700 or to at least one UE 900 within a group of UEs.

Additionally, or alternatively, the RAN node 800 may further comprise a receiver, or a receiving circuitry 830, configured to receive data from other apparatuses, such as the coordinator UE 700 or from at least one UE 900 within a group of UEs.

The memory circuitry 820 stores computer program code which, when run in the processing circuitry 810, causes the RAN node 800 to transmit, to a coordinator UE 700, a configuration configuring at least the coordinator UE 700 with group-shared UL resources and SL resources to be used by the group of UEs. The configuration further indicates that the coordinator UE 700 coordinates scheduling of the group-shared UL resources.

Thus, the RAN node 800 according to the present disclosure enables enhanced scheduling of UL resources in order to reduce latency and processing loads in situations where many UEs may transmit data.

In some embodiments, the RAN node 800 may further be caused to identify the coordinator UE 700. One of the UEs within the group of UEs may be identified, or selected, to operate as the coordinator UE 700. According to some embodiments, the RAN node 800 may select which UE that may be the coordinator UE 700. The coordinator UE 700 may have been selected, or identified, considering at least one of: strongest radio channel quality, location relative the group centre and support the least required buffer size that meets the requirements for the group communication.

In some embodiments, the RAN node 800 may further be caused to transmit, to at least one UE 900 within the group of UEs, the configuration configuring the at least one UE 900 within the group of UEs with group-shared UL resources and SL resources to be used by the group of UEs. The configuration further indicates that the coordinator UE 700 coordinates scheduling of the group-shared UL resources.

In some embodiments, the RAN node 800 may further be caused to receive, from the coordinator UE 700, a request for additional group-shared UL resources. The RAN node 800 may further be caused to transmit, to at least the coordinator UE 700, a configuration configuring additional group-shared UL resources as a response to said request for additional group-shared UL resources. The received request for additional group-shared UL resources may comprise, for example, an indication of an amount of desired group-shared UL resources. Additionally, or alternatively, the received request for additional group-shared UL resources may comprise an aggregated BSR and the aggregated BSR may comprise information of a total buffer status of all UEs within the group of UEs. The aggregated BSR may comprise an identifier indicating that the aggregated BSR is an aggregated BSR.

In some embodiments, the transmitted configuration configuring at least the coordinator UE 700 with group-shared UL resources may be using one of DCI, MAC CE and RRC signalling. In one embodiment, the transmitted configuration configuring the coordinator UE 700 with group-shared UL resources may be addressed to the coordinator UE 700 and may comprise a group index indicating the group of UEs. Alternatively, the transmitted configuration configuring the coordinator UE 700 with group-shared UL resources may be addressed to the coordinator UE 700 and may comprise a group index indicating the group of UEs. The transmitted configuration may be addressed to a RNTI of the coordinator UE 700. In still an alternative embodiment, the transmitted configuration configuring at least the coordinator UE 700 with group-shared UL resources may be addressed to at least one UE 900 within the group of UEs and may comprise a group index indicating the group of UEs. The transmitted configuration may be addressed to a group RNTI.

In some embodiments, the RAN node 800 may further be caused to receive, from the coordinator UE 700, an indication of which configured group-shared UL resources that have been scheduled to which at least one UE 900 within the group of UEs.

According to an alternative embodiment, the RAN node 800 configured to perform the method 500 according to the second aspect may comprise a transmitting unit. The transmitting unit may be configured to transmit, to a coordinator UE 700, a configuration configuring at least the coordinator UE 700 with group-shared UL resources and SL resources to be used by the group of UEs. The RAN node 800 may further comprise a receiving unit.

According to a sixth aspect, there is provided a UE 900 within a group of UEs configured to perform the method 600 according to the third aspect.

The UE 900 within the group of UEs is now going to be described with reference to FIG. 9. The UE 900 may be used in, but are not limited to, wireless communications system.

The UE 900 is configured for receiving resources scheduled for the group of UEs in a wireless communications system. As illustrated in FIG. 9, the UE 900 comprises a processor, or a processing circuitry 910, and a memory, or a memory circuitry 920.

Additionally, or alternatively, the UE 900 may further comprise a transmitter, or a transmitting circuitry 940, configured to transmit data to other apparatuses, such as the coordinator UE 700, to the RAN node 800 or to other UEs within the group of UEs.

Additionally, or alternatively, the UE 900 may further comprise a receiver, or a receiving circuitry 930, configured to receive data from other apparatuses, such as the coordinator UE 700, the RAN node 800 or other UEs within the group of UEs.

The memory circuitry 920 stores computer program code which, when run in the processing circuitry 910, causes the UE 900 to receive, from a RAN node 800 or from a coordinator UE 700, a configuration configuring the UE 900 with SL resources to be used by the group of UEs, and configuring the UE 900 that the coordinator UE 700 coordinates scheduling of group-shared UL resources.

Thus, the UE 900 according to the present disclosure enables enhanced scheduling of UL resources in order to reduce latency and processing loads in situations where many UEs may transmit data.

In some embodiments, the UE 900 may be further caused to receive an indication identifying the coordinator UE 700. The indication may identify which UE that is the coordinator UE 700 coordinating scheduling of the group-shared UL resources. For example, the UE ID, or a temporary ID, of the coordinator UE 700 may be indicated to the UE 900. The indication may be received from the coordinator UE 700 directly. Alternatively, the indication may be received from the RAN node 800.

In some embodiments, the UE 900 may be further caused to transmit via the SL resource, to the coordinator UE 700, a BSR. The UE 900 may be further caused to receive, from the RAN node 800, allocation of group-shared UL resources. Alternatively, or additionally, the UE 900 may be further caused to receive, from the coordinator UE 700, allocation of group-shared UL resources. The allocation of group-shared UL resources may comprise, for example, an indication of which group-shared UL resources to use. The indication of which group-shared UL resources to use may be indicated by a polling chart, which informs the UE 900 when the group-shared UL resources is allowed to use.

In some embodiments, which group-shared UL resources the UE 900 is allowed to use may be indicated by a timing of a configured grant for said group-shared UL resources. The UE 900 may be further caused to receive a DCI using a configured search space on PDCCH.

In some embodiments, the received allocation of group-shared UL resources may be received using one of DCI, MAC CE and RRC signalling. In one embodiment, the received allocation of group-shared UL resources may be addressed to the group of UEs and may comprise a group index indicating the group of UEs. In an alternative embodiment, the received allocation of group-shared UL resources may be addressed to the UE 900 and may comprise a group index indicating the group of UEs.

According to an alternative embodiment, the UE 900 configured to perform the method 600 according to the third aspect may comprise a receiving unit. The receiving unit may be configured to receive, from a RAN node 800 or from a coordinator UE 700, a configuration configuring the UE 900 with SL resources to be used by the group of UEs. The UE 900 may further comprise a transmitting unit.

According to a seventh aspect, there is provided a computer program, comprising instructions which, when executed on a processing circuitry, cause the processing circuitry to carry out the method according to the first aspect, the second aspect and/or the third aspect.

According to an eight aspect, there is provided a carrier containing the computer program of the seventh aspect, wherein the carrier is one of an electronic signal, optical signal, radio signal, or computer readable storage medium.

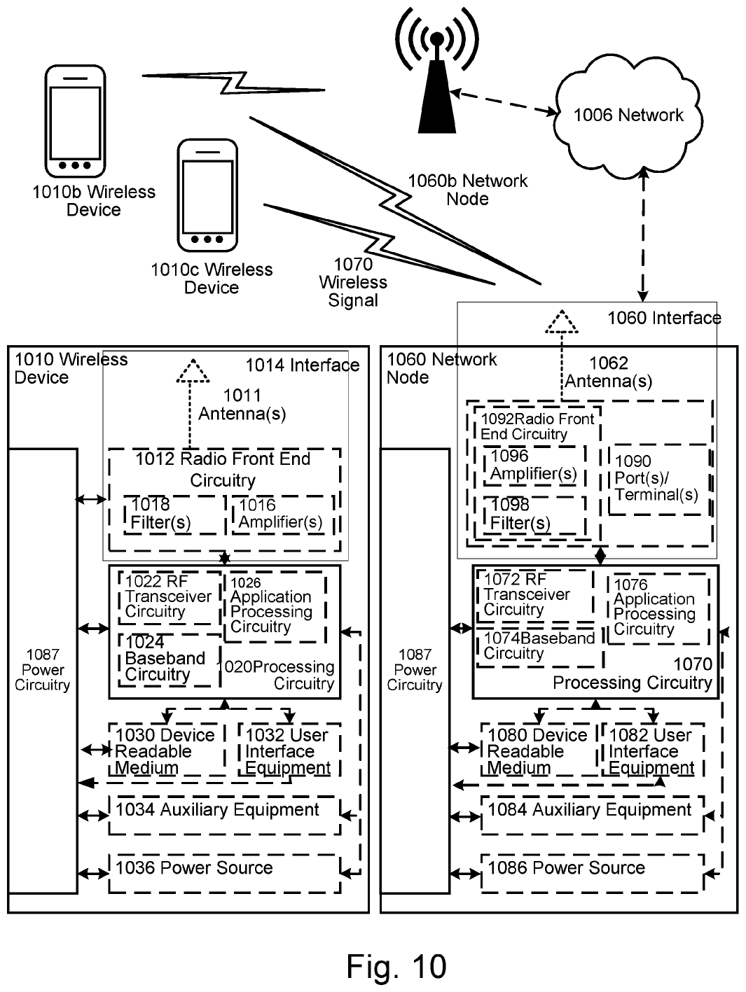

Although the subject matter described herein may be implemented in any appropriate type of system using any suitable components, the embodiments described herein relate to a wireless network, such as the example wireless communication network illustrated in FIG. 10. For simplicity, the wireless communication network of FIG. 10 only depicts network 1006, network nodes 1060 and 1060b, and Wireless Devices (WDs) 1010, 1010b, and 1010c. The wireless communication network may further include any additional elements suitable to support communication between wireless devices or between a wireless device and another communication device, such as a landline telephone. Of the illustrated components, network node 1060 and wireless device (WD) 1010 are depicted with additional detail. The illustrated wireless communication network may provide communication and other types of services to one or more wireless devices to facilitate the wireless devices' access to and/or use of the services provided by the wireless communication network.

The wireless communication network may comprise and/or interface with any type of communication, telecommunication, data, cellular, and/or radio network or other similar type of system. In some embodiments, the wireless communication network may be configured to operate according to specific standards or other types of predefined rules or procedures. Thus, particular embodiments of the wireless communication network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components may work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless communication network to enable and/or provide wireless access to the wireless device and/or to perform other functions (e.g., administration) in the wireless communication network. Examples of network nodes include, but are not limited to, access points (APs) (e.g., radio access points), base stations (BSs) (e.g., radio base stations, Node Bs, and evolved Node Bs (eNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, network node 1060 may be a virtual network node as described in more detail below. More generally, however, network nodes may represent any suitable device (or group of devices) capable, configured, arranged, and/or operable to enable and/or provide a wireless device with access to the wireless communication network or to provide some service to a wireless device that has accessed the wireless communication network.

In FIG. 10, Network node 1060 includes processing circuitry 1070, device readable medium 1080, interface 1090, user interface equipment 1082, auxiliary equipment 1084, power source 1086, power circuitry 1087, and antenna 1062. Although network node 1060 illustrated in the example wireless communication network of Figure may represent a device that includes the illustrated combination of hardware components, other embodiments may comprise network nodes with different combinations of components. It is to be understood that a network node may comprise any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units.

In certain embodiments, some or all of the functionality described herein as being provided by a network node, base station, eNB or other such network device may be provided by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 10100 may be considered to be integrated.

Interface 1090 is used in the wired or wireless communication of signaling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 10 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1013 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1013 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

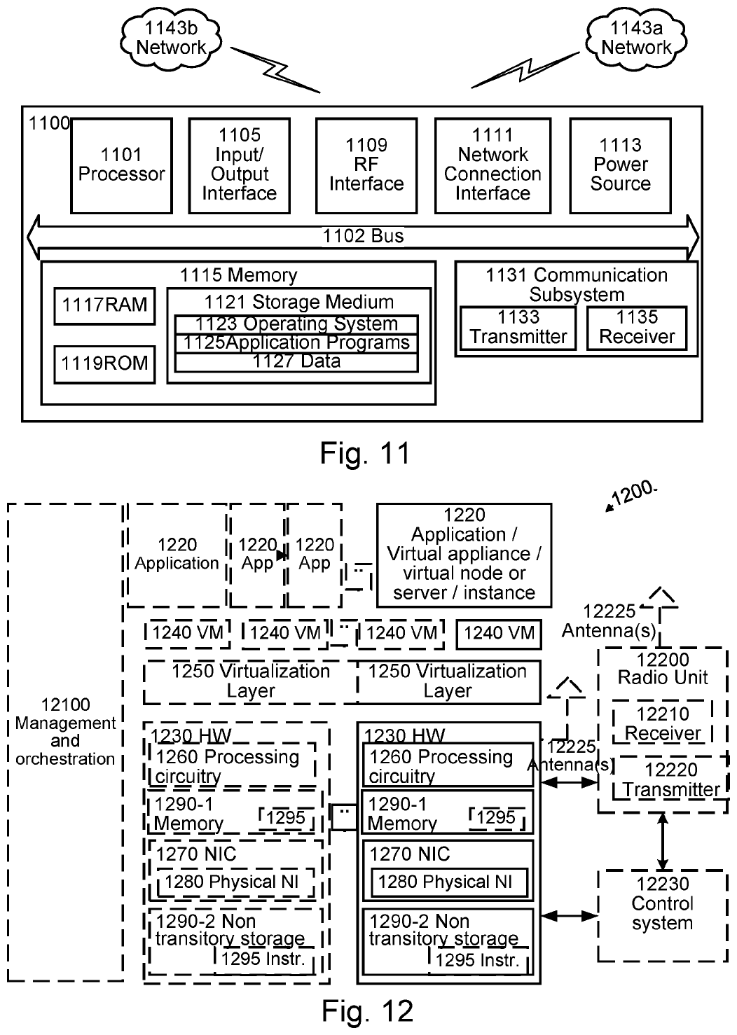

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3rd Generation Partnership Project (3GPP), including a NB-IoT UE, a machine type communication (MTC) UE, and/or an enhanced MTC (eMTC) UE. UE 1100, as illustrated in FIG. 11, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1114, and storage medium 1121 or the like, communication subsystem 1131, power source 1113, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1114 may be configured to provide computer instructions or data to processing circuitry 1101. For example, ROM 1114 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 11, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.9, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power 5 source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analogue hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signaling can be affected with the use of control system 12230 which may alternatively be used for communication between the hardware nodes 1230 and radio units 12200.

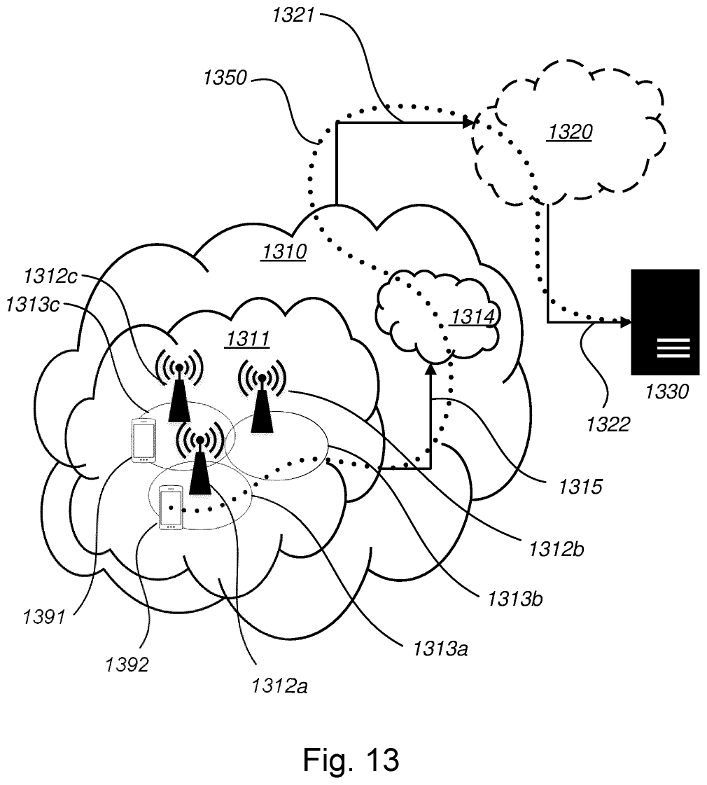

With reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1316 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

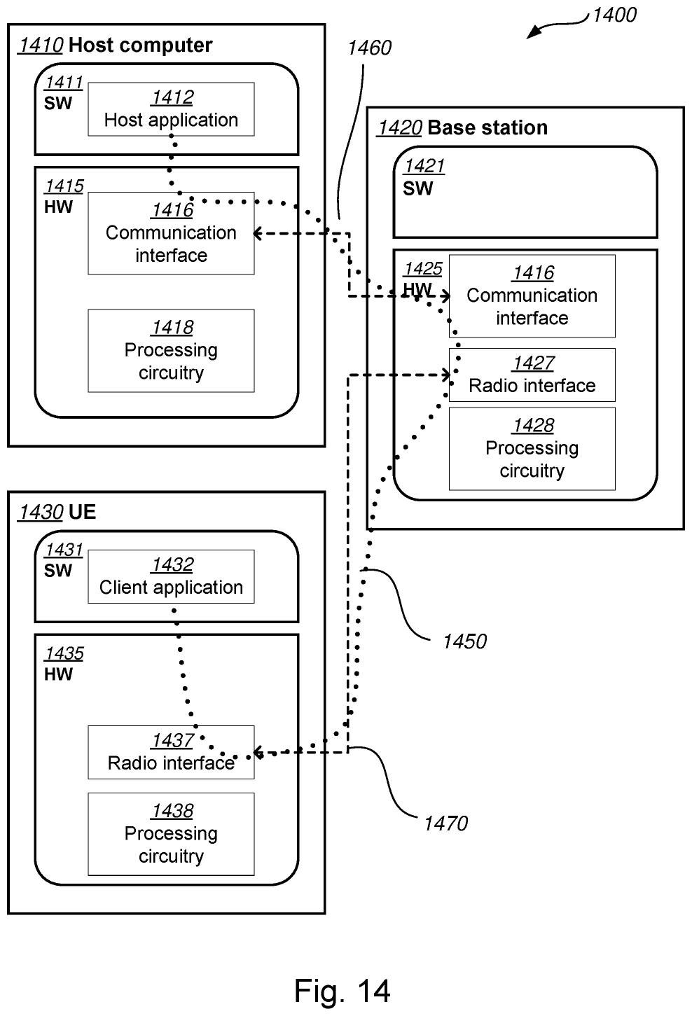

Example implementations, in accordance with an embodiment, of the UE, base station and host computer discussed in the preceding paragraphs will now be described with reference to FIG. 14. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 may be configured to facilitate connection 1460 to host computer 1410. Connection 1460 may be direct, or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1430, one of base stations 1312a, 1312b, 1312c and one of UEs 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the data rate and thereby provide benefits such as better responsiveness.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

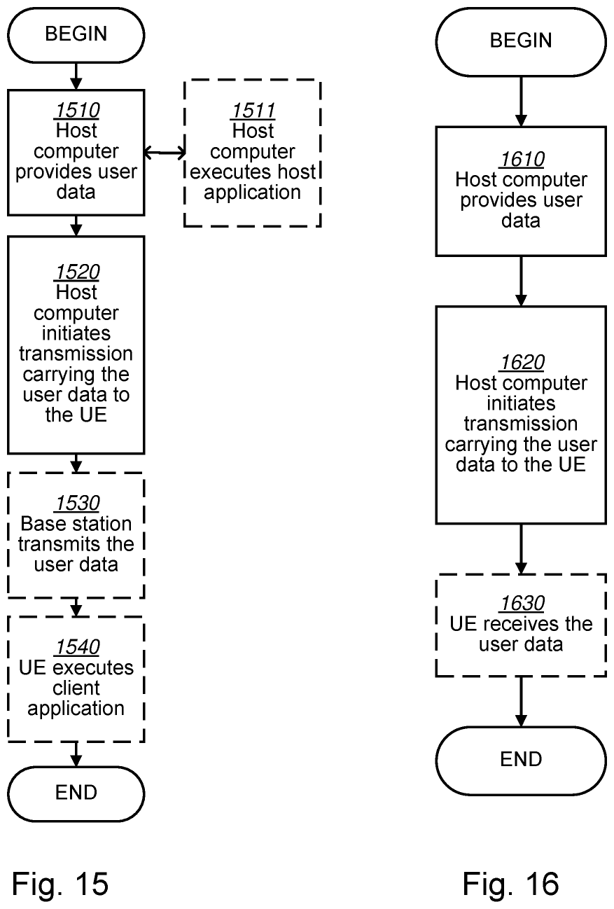

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

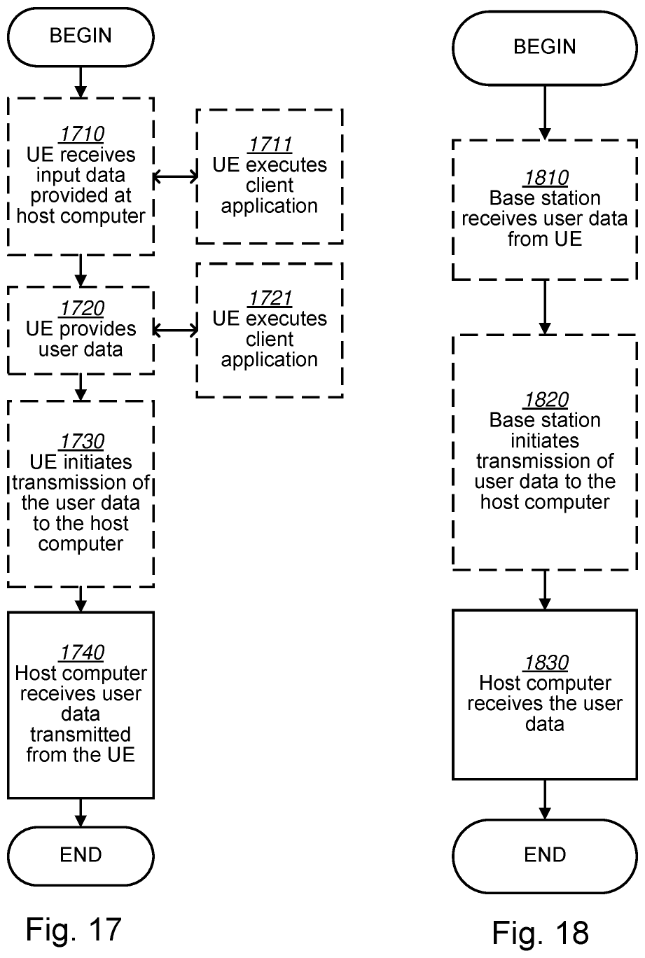

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read-Only Memory (ROM), Random-Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Numbered embodiments in particular related to FIGS. 10-18
1. A Radio Access Network (RAN) node configured to schedule resources for a group of UEs in a wireless communications system, the RAN node comprising a radio interface and processing circuitry configured to:
   transmit, to a coordinator User Equipment (UE) a configuration configuring at least the coordinator UE with group-shared UpLink (UL) resources and SideLink (SL) resources to be used by the group of UEs, and wherein the configuration further indicates that the coordinator UE coordinates scheduling of the group-shared UL resources and wherein the coordinator UE monitors a demand for the group-shared UL resources by at least one UE within the group of UEs.
2. The RAN node according to embodiment 1, wherein the RAN node is further caused to:
   transmit, to at least one UE within the group of UEs, the configuration configuring the at least one UE within the group of UEs with group-shared UL resources and SL resources to be used by the group of UEs and wherein the configuration further indicates that the coordinator UE coordinates scheduling of the group-shared UL resources.
3. The RAN node according to any of embodiments 1 and 2, wherein the RAN node is further caused to:
   receive, from the coordinator UE, a request for additional group-shared UL resources; and
   transmit, to at least the coordinator UE, a configuration configuring additional group-shared UL resources as a response to said request for additional group-shared UL resources.
4. The RAN node according to embodiment 3, wherein the received request for additional group-shared UL resources comprises an indication of an amount of desired group-shared UL resources.
5. The RAN node according to any of embodiments 3 and 4, wherein the received request for additional group-shared UL resources comprises an aggregated BSR and the aggregated BSR comprises information of a total buffer status of all UEs within the group of UEs.
6. The RAN node according to embodiment 5, wherein the aggregated BSR may comprise an identifier indicating that the aggregated BSR is an aggregated BSR.
7. The RAN node according to any of embodiments 2 to 6, wherein the transmitted configuration configuring at least the coordinator UE with group-shared UL resources is using one of DCI, MAC CE and RRC signalling.
8. The RAN node according to embodiment 7, wherein the transmitted configuration configuring the coordinator UE with group-shared UL resources is addressed to the coordinator UE and comprises a group index indicating the group of UEs.
9. The RAN node according to embodiment 8, wherein the transmitted configuration is addressed to a RNTI of the coordinator UE.
10. The RAN node according to embodiment 7, wherein the transmitted configuration configuring at least the coordinator UE with group-shared UL resources is addressed to at least one UE within the group of UEs and comprises a group index indicating the group of UEs.
11. The RAN node according to embodiment 7, wherein the transmitted configuration configuring at least the coordinator UE with group-shared UL resources is addressed to the group of UEs and comprises a group index indicating the group of UEs.
12. The RAN node according to embodiment 10, wherein the transmitted configuration is addressed to a group RNTI.
13. The RAN node according to any of embodiments 1 to 12, wherein the RAN node is further caused to receive, from the coordinator UE, an indication of which configured group-shared UL resources that have been scheduled to which at least one UE within the group of UEs
14. A communication system including a host computer comprising:
   processing circuitry configured to provide user data; and
   a communication interface configured to forward the user data to a cellular network for transmission to a coordinator User Equipment (UE),
   wherein the cellular network comprises a Radio Access Network (RAN) node having a radio interface and processing circuitry, the RAN node's processing circuitry configured to transmit, to the coordinator UE a configuration configuring at least the coordinator UE with group-shared UpLink (UL) resources and SideLink (SL) resources to be used by the group of UEs, and wherein the configuration further indicates that the coordinator UE coordinates scheduling of the group-shared UL resources and wherein the coordinator UE monitors a demand for the group-shared UL resources by at least one UE within the group of UEs.
15. The communication system of embodiment 14, further including the RAN node.
16. The communication system of embodiment 15, further including the coordinator UE, wherein the coordinator UE is configured to communicate with the RAN node.
17. The communication system of embodiment 16, wherein:
   the processing circuitry of the host computer is configured to execute a host application, thereby providing the user data; and
   the coordinator UE comprises processing circuitry configured to execute a client application associated with the host application.
18. A method implemented in a Radio Access Network (RAN) node, comprising
   transmitting, to a coordinator User Equipment, (UE), a configuration configuring at least the coordinator UE with group-shared UL resources and SL resources to be used by the group of UEs, and wherein the configuration further indicates that the coordinator UE coordinates scheduling of the group-shared UL resources and wherein the coordinator UE monitors a demand for the group-shared UL resources by at least one UE within the group of UEs.
19. A method implemented in a communication system including a host computer, a Radio Access Network (RAN) node and a coordinator User Equipment (UE), the method comprising:
   at the host computer, providing user data; and
   at the host computer, initiating a transmission carrying the user data to the coordinator UE via a cellular network comprising the RAN node, wherein the RAN node
      transmitting, to a coordinator User Equipment, (UE), a configuration configuring at least the coordinator UE with group-shared UL resources and SL resources to be used by the group of UEs, and wherein the configuration further indicates that the coordinator UE coordinates scheduling of the group-shared UL resources and wherein the coordinator UE monitors a demand for the group-shared UL resources by at least one UE within the group of UEs.
20. The method of embodiment 19, further comprising:
   at the RAN node, transmitting the user data.
21. The method of embodiment 20, wherein the user data is provided at the host computer by executing a host application, the method further comprising:
   at the UE, executing a client application associated with the host application.
22. A coordinator User Equipment (UE) configured to communicate with a Radio Access Network (RAN) node, the coordinator UE comprising a radio interface and processing circuitry configured to transmit and receive data to and from the RAN node.
23. A communication system including a host computer comprising:
   processing circuitry configured to provide user data; and
   a communication interface configured to forward user data to a cellular network for transmission to a coordinator User Equipment (UE),
   wherein the coordinator UE comprises a radio interface and processing circuitry, the coordinator UE's processing circuitry configured to transmit and receive data to and from a Radio Access Network (RAN) node.
24. The communication system of embodiment 23, further including the coordinator UE.
25. The communication system of embodiment 23, wherein the cellular network further includes a RAN node configured to communicate with the source UE.
26. The communication system of embodiment 24 or 25, wherein:
   the processing circuitry of the host computer is configured to execute a host application, thereby providing the user data; and
   the coordinator UE's processing circuitry is configured to execute a client application associated with the host application.
27. A method implemented in a communication system including a host computer, a Radio Access Network (RAN) node and a coordinator User Equipment (UE), the method comprising:
   at the host computer, providing user data; and
   at the host computer, initiating a transmission carrying the user data to the coordinator UE via a cellular network comprising the RAN node, wherein the coordinator UE transmits and receives to and from the RAN node.
28. The method of embodiment 27, further comprising:
   at the coordinator UE, receiving the user data from the RAN node.
29. A communication system including a host computer comprising:
   a communication interface configured to receive user data originating from a transmission from a coordinator User Equipment (UE) to a Radio Access Network (RAN) node, wherein the coordinator UE comprises a radio interface and processing circuitry, the coordinator UE's processing circuitry configured to transmit and receive data to and from the RAN node.
30. The communication system of embodiment 29, further including the coordinator UE.
31. The communication system of embodiment 30, further including the RAN node, wherein the RAN node comprises a radio interface configured to communicate with the coordinator UE and a communication interface configured to forward to the host computer the user data carried by a transmission from the coordinator UE to the RAN node.
32. The communication system of embodiment 23 or 24, wherein:
   the processing circuitry of the host computer is configured to execute a host application; and the coordinator UE's processing circuitry is configured to execute a client application associated with the host application, thereby providing the user data.
33. The communication system of embodiment 31 or 32, wherein:
   the processing circuitry of the host computer is configured to execute a host application, thereby providing request data; and
   the coordinator UE's processing circuitry is configured to execute a client application associated with the host application, thereby providing the user data in response to the request data.
34. A method implemented in a coordinator User Equipment (UE), comprising transmitting and receiving data to and from a Radio Access Network (RAN) node.
35. The method of embodiment 34, further comprising:

providing user data; and

forwarding the user data to a host computer via the transmission to the RAN node.
36. A method implemented in a communication system including a host computer, a Radio Access Network (RAN) node and a coordinator User Equipment (UE), the method comprising:
   at the host computer, receiving user data transmitted to the RAN node from the UE, wherein the coordinator UE transmitting and receiving data to and from the RAN node.
37. The method of embodiment 36 further comprising:
   at the coordinator UE, providing the user data to the RAN node.
38. The method of embodiment 37, further comprising:
   at the coordinator UE, executing a client application, thereby providing the user data to be transmitted; and
   at the host computer, executing a host application associated with the client application.
39. The method of embodiment 38, further comprising:
   at the coordinator UE, executing a client application; and
   at the coordinator UE, receiving input data to the client application, the input data being provided at the host computer by executing a host application associated with the client application,
   wherein the user data to be transmitted is provided by the client application in response to the input data.
40. A communication system including a host computer comprising a communication interface configured to receive user data originating from a transmission from a coordinator User Equipment (UE) to a Radio Access Network (RAN) node, wherein the RAN node comprises a radio interface and processing circuitry, the RAN node's processing circuitry configured to transmit, to the coordinator UE, a configuration configuring at least the coordinator UE with group-shared UpLink (UL) resources and SideLink (SL) resources to be used by the group of UEs, and wherein the configuration further indicates that the coordinator UE coordinates scheduling of the group-shared UL resources and wherein the coordinator UE monitors a demand for the group-shared UL resources by at least one UE within the group of UEs.
41. The communication system of embodiment 40, further including the RAN node.
42. The communication system of embodiment 41, further including the coordinator UE, wherein the coordinator UE is configured to communicate with the RAN node.
43. The communication system of embodiment 42, wherein:
   the processing circuitry of the host computer is configured to execute a host application;
   the coordinator UE is configured to execute a client application associated with the host application, thereby providing the user data to be received by the host computer.
44. A method implemented in a communication system including a host computer, a Radio Access Network (RAN) node and a coordinator User Equipment (UE), the method comprising:
   at the host computer, receiving, from the RAN node, user data originating from a transmission which the RAN node has received from the coordinator UE, wherein the coordinator UE transmits and receives data to and from the RAN node.
45. The method of embodiment 44, further comprising:
   at the RAN node, receiving the user data from the coordinator UE.
46. The method of embodiment 45, further comprising:
   at the RAN node, initiating a transmission of the received user data to the host computer.
47. A coordinator User Equipment (UE) configured to communicate with a Radio Access Network (RAN) node, the coordinator UE comprising a radio interface and processing circuitry configured to:
   receive, from the RAN node, a configuration configuring at least the coordinator UE with group-shared UpLink (UL) resources and SideLink (SL) resources to be used by the group of UEs, and wherein the configuration further indicates that the coordinator UE coordinates scheduling of the group-shared UL resources;
   monitor a demand for the group-shared UL resources by at least one UE within the group UEs; and
   schedule, based on the monitored demand for the group-shared UL resources, the configured group-shared UL resources to at least one UE within the group of UEs.
48. The coordinator UE according to embodiment 47, wherein the coordinator UE is configured to monitor the demand for the group-shared UL resources by:
   receiving, via the SL resources, a Buffer Status Report, BSR, from at least one UE within the group of UEs.
49. The coordinator UE according to any of embodiments 47 and 48, wherein the coordinator UE is configured to monitor the demand for the group-shared UL resources by:
   monitoring a sum of requested resources in at least one BSR from at least one UE within the group of UEs; and
   if the sum of requested resources in said at least one BSR exceeds the configured group-shared UL resources, transmitting, to the RAN node, a request for additional group-shared UL resources
50. The coordinator UE according to embodiment 49, wherein the request for additional group-shared UL resources comprises an indication of an amount of desired group-shared UL resources based on said sum of requested resources in said at least one BSR.
51. The coordinator UE according to any of embodiment 49 and 50, wherein the request for additional group-shared UL resources comprises an aggregated BSR and the aggregated BSR comprises information of a total buffer status of all UEs within the group of UEs.
52. The coordinator UE according to embodiment 51, wherein the aggregated BSR comprises an identifier indicating that the aggregated BSR is an aggregated BSR.
53. The coordinator UE according to any of embodiments 49 to 51, wherein the coordinator UE further is caused to:
   receive, from the RAN node, a configuration configuring additional group-shared UL resources as a response to said transmitted request for additional group-shared UL resources.
54. The coordinator UE according to embodiment 53, wherein the coordinator further is caused to:
   allocate partial or all the received additional group-shared UL resources to at least one UE within the group of UEs that has data to transmit.
55. The coordinator UE (300) according to any of embodiments 47 to 54, wherein the coordinator UE further is caused to:
   transmit, to the group of UEs, a configuration configuring the group of UEs with the SL resources to be used by the group of UEs and configuring the group of UEs that the coordinator UE coordinates the use of the group-shared UL resources.
56. The coordinator UE (300) according to any of embodiments 47 to 55, wherein the coordinator UE is caused to schedule the configured group-shared UL resources to at least one UE within the group of UEs by:
   indicating to the at least one UE within the group of UEs which group-shared UL resources to use.
57. The coordinator UE according to embodiment 56, wherein which group-shared UL resources the at least one UE within the group of UEs is allowed to use is indicated to said UE by indicating a timing of a configured grant for said group-shared UL resources.
58. The coordinator UE according to any of embodiments 56 and 57, wherein the coordinator UE is caused to indicate to the at least one UE within the group of UEs which group-shared UL resources to use by:
   transmitting, so said at least one UE within the group of UEs, a Downlink Control Information (DCI) using a configured search space on Physical Sidelink Common Control Channel (PDCCH).
59. The coordinator UE according to embodiment 56, wherein which group-shared UL resources the at least one UE within the group of UEs is allowed to use is indicated to said UE by a polling chart, which informs said UE when the group-shared UL resources is allowed to use.
60. The coordinator UE according to any of embodiments 47 to 59, wherein the coordinator UE further is caused to:
   transmit, to the RAN node, an indication of which configured group-shared UL resources that have been scheduled to which at least one UE within the group of UEs.
61. The coordinator UE according to any of embodiments 47 to 60, wherein the received configuration configuring the coordinator UE with group-shared UL resources is using one of DCI, Media Access Control (MAC) Control Element (CE) and Radio Resource Control (RRC) signaling.
62. The coordinator UE according to embodiment 61, wherein the received configuration configuring the coordinator UE with group-shared UL resources is addressed to the coordinator UE and comprises a group index indicating the group of UEs.
63. The coordinator UE according to embodiment 62, wherein the received configuration is addressed to a Radio Network Temporary Identifier (RNTI) of the coordinator UE.
64. The coordinator UE according to embodiment 61, wherein the received configuration configuring the coordinator UE with group-shared UL resources is addressed to at least one UE within the group of UEs and comprises a group index indicating the group of UEs.
65. The coordinator UE according to embodiment 61, wherein the received configuration configuring the coordinator UE with group-shared UL resources is addressed to the group of UEs and comprises a group index indicating the group of UEs.
66. The coordinator UE according to embodiment 65, wherein the received configuration is addressed to a group RNTI.
67. A communication system including a host computer comprising:
   processing circuitry configured to provide user data; and
   a communication interface configured to forward the user data to a cellular network for transmission to a coordinator User Equipment (UE), wherein the cellular network comprises a RAN node having a radio interface and processing circuitry, the RAN node's processing circuitry configured to transmit, to the coordinator UE a configuration configuring at least the coordinator UE with group-shared UpLink (UL) resources and SideLink (SL) resources to be used by the group of UEs, and wherein the configuration further indicates that the coordinator UE coordinates scheduling of the group-shared UL resources and wherein the coordinator UE monitors a demand for the group-shared UL resources by at least one UE within the group of UEs.
68. The communication system of embodiment 67, further including the RAN node.
69. The communication system of embodiment 68, further including the source UE, wherein the coordinator UE is configured to communicate with the RAN node.
70. The communication system of embodiment 69, wherein:
   the processing circuitry of the host computer is configured to execute a host application, thereby providing the user data; and
   the coordinator UE comprises processing circuitry configured to execute a client application associated with the host application.
71. A method implemented in a coordinator UE, comprising
   receiving, from the RAN node, a configuration configuring at least the coordinator UE with group-shared UpLink (UL) resources and SideLink (SL) resources to be used by the group of UEs, and wherein the configuration further indicates that the coordinator UE coordinates scheduling of the group-shared UL resources;
   monitoring a demand for the group-shared UL resources by at least one UE within the group UEs; and
   scheduling, based on the monitored demand for the group-shared UL resources, the configured group-shared UL resources to at least one UE within the group of UEs.
72. A method implemented in a communication system including a host computer, a coordinator User Equipment (UE) and a Radio Access Network (RAN) node, the method comprising:
   at the host computer, providing user data; and
   at the host computer, initiating a transmission carrying the user data to the coordinator UE via a cellular network comprising the coordinator UE, wherein the coordinator UE
      receiving, from the RAN node, a configuration configuring at least the coordinator UE with group-shared UpLink (UL) resources and SideLink (SL) resources to be used by the group of UEs, and wherein the configuration further indicates that the coordinator UE coordinates scheduling of the group-shared UL resources;
      monitoring a demand for the group-shared UL resources by at least one UE within the group UEs; and
      scheduling, based on the monitored demand for the group-shared UL resources, the configured group-shared UL resources to at least one UE within the group of UEs.
73. The method of embodiment 72, further comprising:
   at the coordinator UE, transmitting the user data.
74. The method of embodiment 73, wherein the user data is provided at the host computer by executing a host application, the method further comprising:
   at the coordinator UE, executing a client application associated with the host application.
75. A coordinator User Equipment (UE) configured to communicate with a Radio Access Network (RAN) node, the coordinator UE comprising a radio interface and processing circuitry configured to transmit and receive data to and from the RAN node.
76. A communication system including a host computer comprising:
   processing circuitry configured to provide user data; and
   a communication interface configured to forward user data to a cellular network for transmission to a coordinator User Equipment (UE),
   wherein the coordinator UE comprises a radio interface and processing circuitry, the coordinator UE's processing circuitry configured to transmit and receive data to and from a Radio Access Network (RAN) node.
77. The communication system of embodiment 76, further including the coordinator UE.
78. The communication system of embodiment 77, wherein the cellular network further includes a RAN node configured to communicate with the coordinator UE.
79. The communication system of embodiment 76 or 77, wherein:
   the processing circuitry of the host computer is configured to execute a host application, thereby providing the user data; and
   the coordinator UE's processing circuitry is configured to execute a client application associated with the host application.
80. A method implemented in a communication system including a host computer, a coordinator User Equipment (UE) and Radio Access Network (RAN) node, the method comprising:
   at the host computer, providing user data; and
   at the host computer, initiating a transmission carrying the user data to the RAN node via a cellular network comprising the RAN node, wherein the coordinator UE transmits and receives to and from the RAN node.
81. The method of embodiment 80, further comprising:
   at the coordinator UE, receiving the user data from the RAN node.
82. A communication system including a host computer comprising:
   a communication interface configured to receive user data originating from a transmission from a coordinator User Equipment (UE) to a Radio Access Network (RAN) node,
   wherein the coordinator UE comprises a radio interface and processing circuitry, the coordinator UE's processing circuitry configured to transmit and receive data to and from the RAN node.
83. The communication system of embodiment 82, further including the coordinator UE.
84. The communication system of embodiment 83, further including the RAN node, wherein the RAN node comprises a radio interface configured to communicate with the coordinator UE and a communication interface configured to forward to the host computer the user data carried by a transmission from the coordinator UE to the RAN node.
85. The communication system of embodiment 83 or 84, wherein:
   the processing circuitry of the host computer is configured to execute a host application;
   and the coordinator UE's processing circuitry is configured to execute a client application associated with the host application, thereby providing the user data.
86. The communication system of embodiment 84 or 85, wherein:
   the processing circuitry of the host computer is configured to execute a host application, thereby providing request data; and
   the coordinator UE's processing circuitry is configured to execute a client application associated with the host application, thereby providing the user data in response to the request data.
87. A method implemented in a coordinator User Equipment (UE), comprising transmitting and receiving data to and from a Radio Access Network (RAN) node.
88. The method of embodiment 87, further comprising:
   providing user data; and
   forwarding the user data to a host computer via the transmission to the RAN node.
89. A method implemented in a communication system including a host computer, a coordinator User Equipment (UE) and a Radio Access Network (RAN) node, the method comprising:
   at the host computer, receiving user data transmitted to the RAN node from the coordinator UE, wherein the coordinator UE transmitting and receiving data to and from the RAN node.
90. The method of embodiment 89, further comprising:
   at the coordinator UE, providing the user data to the RAN node.
91. The method of embodiment 90, further comprising:
   at the coordinator UE, executing a client application, thereby providing the user data to be transmitted; and
   at the host computer, executing a host application associated with the client application.
92. The method of embodiment 91, further comprising:
   at the coordinator UE, executing a client application; and
   at the coordinator UE, receiving input data to the client application, the input data being provided at the host computer by executing a host application associated with the client application, wherein the user data to be transmitted is provided by the client application in response to the input data.
93. A communication system including a host computer comprising a communication interface configured to receive user data originating from a transmission from a coordinator User Equipment (UE) to a Radio Access Network (RAN) node, wherein the coordinator UE comprises a radio interface and processing circuitry, the coordinator UE's processing circuitry configured to receive, from the RAN node, a configuration configuring at least the coordinator UE with group-shared UpLink (UL) resources and SideLink (SL) resources to be used by the group of UEs, and wherein the configuration further indicates that the coordinator UE coordinates scheduling of the group-shared UL resources; monitor a demand for the group-shared UL resources by at least one UE within the group UEs; and schedule, based on the monitored demand for the group-shared UL resources, the configured group-shared UL resources to at least one UE within the group of UEs.
94. The communication system of embodiment 93, further including the RAN node.
95. The communication system of embodiment 94, further including the coordinator UE, wherein the coordinator UE is configured to communicate with the RAN node.
96. The communication system of embodiment 95, wherein:
   the processing circuitry of the host computer is configured to execute a host application;
   the coordinator UE is configured to execute a client application associated with the host application, thereby providing the user data to be received by the host computer.
97. A method implemented in a communication system including a host computer, a coordinator User Equipment (UE) and a Radio Access Network (RAN) node, the method comprising:
   at the host computer, receiving, from the RAN node, user data originating from a transmission which the RAN node has received from the coordinator UE, wherein the coordinator UE transmits and receives data to and from the RAN node.
98. The method of embodiment 97, further comprising:
   at the RAN node, receiving the user data from the coordinator UE.
99. The method of embodiment 98, further comprising:
   at the RAN node, initiating a transmission of the received user data to the host computer.
      The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.
      Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.
      Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1.-94. (canceled)

95. A method in a coordinator User Equipment, UE, for scheduling resources for a group of UEs in a wireless communications system, the method comprising:
receiving, from a Radio Access Network, RAN, node a configuration configuring at least the coordinator UE with group-shared UpLink, UL, resources and SideLink, SL, resources to be used by the group of UEs, and wherein the configuration further indicates that the coordinator UE coordinates scheduling of the group-shared UL resources;
monitoring a demand for the group-shared UL resources by at least one UE within the group of UEs; and
scheduling, based on the monitored demand for the group-shared UL resources, the configured group-shared UL resources to at least one UE within the group of UEs.

96. The method according to claim 95, wherein monitoring the demand for the group-shared UL resources comprises:
receiving, via the SL resources, a Buffer Status Report, BSR, from at least one UE within the group of UEs.

97. The method according to claim 95, wherein monitoring the demand for the group-shared UL resources further comprises:
monitoring a sum of requested resources in at least one BSR from at least one UE within the group of UEs; and
if the sum of requested resources in said at least one BSR exceeds the configured group-shared UL resources, transmitting, to the RAN node, a request for additional group-shared UL resources.

98. The method according to claim 97, wherein the request for additional group-shared UL resources comprises an indication of an amount of desired group-shared UL resources based on said sum of requested resources in said at least one BSR.

99. The method according to any of claim 97, wherein the request for additional group-shared UL resources comprises an aggregated BSR and the aggregated BSR comprises information of a total buffer status of all UEs within the group of UEs.

100. The method according to claim 99, wherein the aggregated BSR comprises an identifier indicating that the aggregated BSR is an aggregated BSR.

101. The method according to claim 97, wherein the method further comprises:
receiving, from the RAN node, a configuration configuring additional group-shared UL resources as a response to said transmitted request for additional group-shared UL resources.

102. The method according to claim 101, wherein the method further comprises:
allocating partial or all the received additional group-shared UL resources to at least one UE within the group of UEs that has data to transmit.

103. The method according to claim 95, wherein the method further comprises:
transmitting, to the group of UEs, a configuration configuring the group of UEs with the SL resources to be used by the group of UEs and configuring the group of UEs that the coordinator UE coordinates the use of the group-shared UL resources.

104. The method according to claim 95, wherein scheduling the configured group-shared UL resources to at least one UE within the group of UEs comprises:
indicating to the at least one UE within the group of UEs which group-shared UL resources to use.

105. The method according to claim 104, wherein which group-shared UL resources the at least one UE within the group of UEs is allowed to use is indicated to said UE by indicating a timing of a configured grant for said group-shared UL resources.

106. The method according to any of claim 104, wherein indicating to the at least one UE within the group of UEs which group-shared UL resources to use comprises:
transmitting, to said at least one UE within the group of UEs, a Downlink Control Information, DCI, using a configured search space on Physical Sidelink Common Control Channel, PDCCH.

107. The method according to claim 95, wherein the method further comprises:
transmitting, to the RAN node, an indication of which configured group-shared UL resources that have been scheduled to which at least one UE within the group of UEs.

108. A method in a Radio Access Network, RAN, node for scheduling and/or allocating resources for a group of UEs in a wireless communications system, the method comprising:
transmitting, to a coordinator User Equipment, UE, a configuration configuring at least the coordinator UE with group-shared UpLink, UL, resources and SideLink, SL, resources to be used by the group of UEs, and wherein the configuration further indicates that the coordinator UE coordinates scheduling of the group-shared UL resources.

109. The method according to claim 108, wherein the method further comprises:
transmitting, to at least one UE within the group of UEs, the configuration configuring the at least one UE within the group of UEs with group-shared UL resources and SL resources to be used by the group of UEs, and wherein the configuration further indicates that the coordinator UE coordinates scheduling of the group-shared UL resources.

110. A method in a User Equipment, UE, within a group of UEs for receiving resources scheduled for the group of UEs in a wireless communications system, the method comprising:
receiving, from a Radio Access Network, RAN node or from a coordinator UE, a configuration configuring the UE with SideLink, SL, resources to be used by the group of UEs, and configuring the UE that the coordinator UE coordinates scheduling of group-shared UL resources.

111. The method according to claim 110, wherein the method further comprises:
transmitting via the SL resource, to the coordinator UE, a Buffer Status Report, BSR.

112. The method according to claim 111, wherein the method further comprises:
receiving, from the RAN node, allocation of group-shared UL resources.

113. The method according to claim 110, wherein the method further comprises:
receiving, from the coordinator UE, allocation of group-shared UL resources.

114. A coordinator User Equipment, UE, configured for scheduling resources for a group of UEs in a wireless communications system, wherein the coordinator UE comprises:
a processing circuitry; and
a memory circuitry storing computer program code which, when run in the processing circuitry, causes the coordinator UE to:
receive, from a Radio Access Network, RAN, node, a configuration configuring at least the coordinator UE with group-shared UpLink, UL, resources and SideLink, SL, resources to be used by the group of UEs, and wherein the configuration further indicates that the coordinator UE coordinates scheduling of the group-shared UL resources;
monitor a demand for the group-shared UL resources by at least one UE within the group UEs; and
schedule, based on the monitored demand for the group-shared UL resources, the configured group-shared UL resources to at least one UE within the group of UEs.
